(19) United States
(12) Patent Application Publication
(10) Pub. No.: US 2014/0379476 A1
(43) Pub. Date: Dec. 25, 2014

(54) METHOD AND DATA PROCESSING APPARATUS

(71) Applicant: Sensewhere Limited, Edinburgh (GB)

(72) Inventors: Robert Ian PALFREYMAN, Impington (GB); Tughrul Sati ARSLAN, Edinburgh (GB); Firas ALSEHLY, Edinburgh (GB); Zankar SEVAK, Edinburgh (GB); Syed Usman BASHA, Edinburgh (GB)

(21) Appl. No.: 13/923,864

(22) Filed: Jun. 21, 2013

(51) Int. Cl. G06Q 30/02; H04W 8/02

(52) U.S. Cl. CPC G06Q 30/0267; H04W 8/02; G06Q 30/0261
USPC 705/14.58

(57) ABSTRACT

The invention provides a method of outputting location specific data to a user interface of a mobile device, the method comprising: obtaining data representing one or more activity patterns associated with the mobile device; selecting a location specific data portion from one or more location specific data portions responsive to a determination that the data representing one or more of the one or more activity patterns meet one or more relevance criteria associated with the said location specific data portion; and outputting to the user interface data from the selected location specific data portion or data associated with the selected location specific data portion.

### FIELD OF THE INVENTION

The invention relates to a method of outputting location specific data to a user interface of a mobile device, data processing apparatus, a method of generating data representing one or more activity patterns of a mobile device and a non-transitory computer readable medium retrievably storing computer readable code for causing a computer to perform the steps of a method of outputting location specific data to a user interface of a mobile device or a method of generating data representing one or more activity patterns of a mobile device.

### BACKGROUND TO THE INVENTION

As personal computing devices such as mobile smartphones or tablets equipped with positioning systems become more widespread, it is becoming more common to present advertisements to users based on their current location (e.g. based on an estimated position of their mobile smartphones). By selecting advertisements based on the current location of a device, more relevant advertisements can be provided thereto.

However, the location of a user (based on the estimated position of the device) does not necessarily provide an accurate indication that the user will be interested in a particular advertisement. Thus, users are commonly provided with advertisements which are not of interest to them.

It would be beneficial (both to advertisers and to users) to develop a method of improving the relevance of advertisements targeted at users of such devices. More generally, it would also be beneficial to develop a method of delivering location specific information to devices which is of interest to the users of those devices.

### SUMMARY OF THE INVENTION

A first aspect of the invention provides a method of outputting location specific data to a user interface of a mobile device, the method comprising: obtaining data representing one or more activity patterns associated with the mobile device; selecting a location specific data portion from one or more location specific data portions responsive to a determination that the data representing one or more of the one or more activity patterns meet one or more relevance criteria associated with the said location specific data portion; and outputting to the user interface data from the selected location specific data portion or data associated with the selected location specific data portion.

It will be understood that, preferably, the steps of the method are performed in order (i.e. in the order presented above).

It will also be understood that, preferably, the steps of the method are performed automatically (rather than manually).

It will also be understood that the step of “selecting a location specific data portion” includes prioritising one location specific data portion over one or more other location specific data portions (from which data may also be output to the user device after data from or associated with the selected location specific data portion has been output) as well as choosing one of the location specific data portion at the exclusion of one or more other location specific data portions.

The method may further comprise (typically between the steps of obtaining data representing one or more activity patterns associated with the mobile device and the step of selecting a location specific data portion from the one or more location specific data portions) determining a relevance to the mobile device of each of one or more location specific data portions by determining whether the said data representing the said one or more activity patterns of the device meet one or more relevance criteria associated with the respective location specific data portions.

The location specific data portions may include for example but not exclusively media files such as image files and/or audio files and/or video files and/or web pages or portions thereof.

It may be that the said one or more location specific data portions are organised into categories. The method may comprise selecting one or more location specific data portion categories; and the step of selecting a location specific data portion may comprise selecting a location specific data portion from one of the one or more selected location specific data portion categories (and not typically from an unselected location specific data portion category). For example, the location specific data portions may comprise advertisements from a first source and advertisements from a second source. The advertisements from the first source may be categorised in a first location specific data portion category and the advertisements from the second source may be categorised into a second location specific data portion category. The method may comprise selecting the first location specific data portion category; and selecting an advertisement from the said selected, first location specific data portion category (and not typically selecting an advertisement from the second, unselected location specific data portion category).

By selectively outputting data from or associated with the selected location specific data portion, location specific data relevant to the device (based on its activity patterns) can be provided to its user interface. Activity patterns of the device may be indicative of the habits of a user of the mobile device, thus providing information which can be used to prioritise data output to the user interface. The location specific data portions may contain (location specific) advertisements, sales offers, relevant travel conditions (e.g. bus, train or aeroplane schedules, live departure boards, road closures, heavy traffic) and so on which may be of interest to a user of the mobile device.

The step of obtaining data representing the activity patterns of the device may comprise retrieving said data from a user profile associated with a user of the device (e.g. stored in a user profile database).

It may be that data representing one or more of the activity patterns of the device is permanently provided in the user profile.

It may be that data representing one or more of the activity patterns of the device is temporarily (e.g. periodically or for one-off time periods) provided in the user profile.

It may be that the user profile permanently comprises data representing one or more activity patterns of the device and the user profile temporarily comprises data representing one or more other activity patterns of the device. Alternatively, it may be that the data representing all of the activity patterns of the device is temporarily (e.g. periodically or for one-off time periods) provided in the user profile.

The method typically comprises dynamically updating the user profile. The method may further comprise: obtaining data from the dynamically updated data representing one or more activity patterns associated with the device from the user profile; selecting a location specific data portion from one or more location specific data portions responsive to a determination that the data from the dynamically updated data representing one or more of the one or more activity patterns meet one or more relevance criteria associated with the said location specific data portion; and outputting to the user interface data from the selected location specific data portion or data associated with the selected location specific data portion. Dynamically updating the user profile may comprise temporary data representing one or more activity patterns of the user being removed from the user profile over time, and/or (temporary or permanent) data representing one or more other activity patterns of the device being added to the user profile over time. Accordingly, the method may comprise dynamically amending (updating) the data representing the activity patterns associated with the device (which is used to determine the relevance of the location specific data portions to the device) over time (thus keeping the said data up to date with the current interests of a user of the device).

Data representing one or more of the activity patterns of the device may be associated with one or more times (e.g. particular times of day, and/or one or more particular days of the week and/or months of the year). Accordingly, the method may comprise dynamically updating the user profile to (e.g. temporarily) include data representing one or more activity patterns at the said times.

It may be that the step of selecting a location specific data portion from the one or more location specific data portions is performed by a server in data communication with the mobile device. The method may further comprise (the server) transmitting data from the selected location specific data portion or data associated with the selected location specific data portion to the mobile device (e.g. over a data communications network, such as a 2.5G, 3G, 4G mobile communications network, or the internet (e.g. via one or more Wi-Fi Access Points)).

The method may comprise the server transmitting data from the selected location specific data portion or data associated with the selected location specific data portion to the mobile device in response to a request received by the server from the mobile device. Alternatively, the method may comprise the server transmitting (“pushing”) the data from the selected location specific data portion or data associated with the selected location specific data portion to the mobile device automatically/autonomously (i.e. without having to receive a request from the mobile device). The method may comprise the server transmitting (“pushing”) the data from the selected location specific data portion or data associated with the selected location specific data portion to the mobile device responsive to a determination that the data representing one or more activity patterns of the device meets one or more relevance criteria associated with the said location specific data portion.

Additionally or alternatively, the method may comprise the server transmitting (“pushing”) the data from the selected location specific data portion or data associated with the selected location specific data portion to the mobile device at one or more particular times (e.g. at one or more times associated with the said location specific data portion and/or at one or more times associated with one or more of the said one or more activity patterns of the mobile device and/or at one or more times when a time associated with the said location specific data portion matches a time associated with one or more of the said one or more activity patterns of the device).

Additionally or alternatively, the method may comprise the server transmitting (“pushing”) the data from the selected location specific data portion or data associated with the selected location specific data portion to the mobile device responsive to a determination that the mobile device is at a particular position or in a particular geographical region (e.g. a position or geographical region associated with the said location specific data portion and/or with one or more of the said one or more activity patterns of the device) or that the mobile device is approaching a particular position or geographical region (e.g. a position or geographical region associated with the said location specific data portion and/or with one or more of the said one or more activity patterns of the device) or that the mobile device is moving away from a particular position or geographical region (e.g. a position or geographical region associated with the said location specific data portion and/or with one or more of the said one or more activity patterns of the device).

It will be understood that the method may further comprise a user of the mobile device registering for service whereby data from the selected location specific data portion or data associated with the selected location specific data portion is automatically/autonomously transmitted to the mobile device by the server.

The step of selecting a location specific data portion from the one or more location specific data portions may be performed by the server in response to a request received from the mobile device. Alternatively, the server may perform the step of selecting a location specific data portion from the one or more location specific data portions automatically/autonomously (i.e. without having to receive a request from the mobile device). For example, the server may perform the step of selecting a location specific data portion from the one or more location specific data portions at regular or irregular time periods.

The method may comprise (the server) selecting a location specific data portion from one or more location specific data portions at one or more particular times (e.g. at one or more times associated with the said location specific data portion and/or at one or more times associated with one or more of the said one or more activity patterns of the mobile device and/or at one or more times when a time associated with the said location specific data portion matches a time associated with one or more of the said one or more activity patterns of the device) or responsive to a determination that the mobile device is at a particular position or in a particular geographical region (e.g. a position or geographical region associated with one or more of the said one or more activity patterns of the device and/or associated with the said location specific data portion) or that the mobile device is approaching a particular position or geographical region (e.g. a position or geographical region associated with one or more of the said one or more activity patterns of the device and/or associated with the said location specific data portion) or that the mobile device is moving away from a particular position or geographical region (e.g. a position or geographical region associated with one or more of the said one or more activity patterns of the device and/or associated with the said location specific data portion).

The method may further comprise: receiving a request (e.g. from the device) for one or more location specific data portions; and adding to or removing from the user profile data representing one or more activity patterns responsive to a determination that a time associated with the request matches or does not match time data associated with the said activity pattern(s). The time associated with the request may be a time at which the request was made or a time at which the request was received (for example).

The request may be an explicit request for a location specific data portion. Alternatively, the request may be an implicit request for location specific data portions (e.g. data transmitted to the server which is interpreted by the server as such a request, the said data not explicitly requesting a location specific data portion from the server). The request may for example be data representing an estimated position of the device which is interpreted by the server as a request for one or more location specific data portions.

Data representing one or more of the activity patterns may be associated with one or more locations or one or more geographical regions. For example the data representing one or more of the activity patterns may be associated with the entrance to an amenity (such as a train station) or a region surrounding a particular feature (such as a sports stadium). Accordingly, the method may comprise dynamically updating the user profile to (e.g. temporarily) include data representing an activity pattern of the device responsive to a determination that the device is estimated to be at or approaching (or in the vicinity of) a position associated with the said activity pattern (e.g. by a positioning module of the mobile device, such as a satellite positioning module). Additionally or alternatively, the method may comprise dynamically updating the user profile to remove data representing an activity pattern of the device responsive to a determination that the device is not at or approaching (or in the vicinity of) a position associated with a said activity pattern. The position may be, for example, an entrance to an amenity, geographical feature or premises of a local business (e.g. train station or coffee shop), or a position on or within a notional (fixed or adjustable) perimeter surrounding an amenity, geographical feature or local business premises, or a (fixed or adjustable) geographical region.

The location specific data portions are typically georeferenced to a particular location (e.g. a single latitude/longitude position) or to a particular geographical area. Accordingly, the method may further comprise comparing an estimated position of the device with a location or area to which a location specific data portion is georeferenced; and selecting the location specific data portion responsive to a determination that the estimated location of the device is at or approaching the said location or area. The step of outputting to the user interface data from the selected location specific data portion or data associated with the selected location specific data portion (and/or the step of the server transmitting (“pushing”) data from the selected location specific data portion or data associated with the selected location specific data portion to the mobile device (automatically/autonomously) where appropriate) may additionally or alternatively be performed responsive to a determination that the mobile device is at or is approaching a position associated with the selected location specific data portion.

The step of outputting to the user interface data from the selected location specific data portion or data associated with the selected location specific data portion (and/or the step of the server transmitting (“pushing”) data from the selected location specific data portion or data associated with the selected location specific data portion to the mobile device (automatically/autonomously) where appropriate) may be performed responsive to a determination that a time associated with a request for a location specific data portion (e.g. a time at which the request was generated or transmitted by the mobile device) matches time data associated with the said selected location specific data portion (e.g. time data provided in the said relevance criteria).

The method may comprise: receiving a request (e.g. from the mobile device) for a location specific data portion; comparing a time associated with the request (e.g. a time when the request was transmitted, e.g. by the mobile device or received, e.g. by a server) with time data associated with one or more location specific data portions (e.g. provided in the relevance criteria); and outputting to the user interface data from or associated with one or more of location specific data portions responsive to a determination that the time associated with the request matches time data associated with the said one or more location specific data portions (e.g. time data provided in the said relevance criteria).

The method may comprise: receiving a request (e.g. from the mobile device) for a location specific data portion; comparing a time associated with the request (e.g. a time when the request was transmitted, e.g. by the mobile device or received, e.g. by a server) with time data associated with one or more location specific data portions (e.g. provided in the relevance criteria); and not outputting to the user interface data from or associated with one or more of location specific data portions responsive to a determination that the time associated with the request does not match time data associated with the said one or more location specific data portions (e.g. time data provided in the said relevance criteria).

The method may comprise automatically generating (e.g. by the mobile device, or a server) a said request for a location specific data portion, for example, a request for a location specific data portion may be generated periodically, a request for a location specific data portion may be generated responsive to an event, for example at a specific time or responsive to determination that a device is in a specific location, or at a position or following a route associated with a respective activity category (discussed below). User interface data from a selected location specific data portion or data associated with a selected location specific data portion may be output responsive thereto. Accordingly, the output of user interface data from a selected location specific data portion or data associated with a selected location specific data portion may be event driven.

The time may be (for example) a time of day and/or a day of the week and/or a group of days of the week (e.g. weekend, weekday).

The activity patterns may comprise one or more patterns of movement of the device. Accordingly, the data representing the activity patterns may be (typically directly) associated with one or more patterns of movement of the device. One or more of the said patterns of movement of the device may comprise repeated locations of the device (e.g. a location regularly visited by the device or one or more “base locations” of the device at which the device is located for a time period exceeding a base threshold time period such as 1 hour or 5 hours on one day or on a plurality of days, or on each day of a plurality of successive days) and/or one or more of the patterns of movement may comprise a repeated sequence of positions of the device (e.g. a repeated route followed by the device). In one example, a pattern of movement of the device may comprise a regularly followed route between two train stations. This pattern of movement may be directly associated with an activity of “commuting”. Accordingly, the data representing the said activity pattern may comprise an indicator that the user is a “commuter”, which is directly associated with the pattern of movement. In other examples, the patterns of movement of the device may be indicative that a user is a supporter of a particular sports team, that a user is a regular shopper at a particular store or mall, etc, and the data representing the activity patterns associated with the device may reflect the user's patterns of attending sports events or the user's shopping habits respectively.

The method may comprise determining one or more patterns of movement of the device.

The method (e.g. the step of determining one or more patterns of movement of the device) may comprise obtaining location data indicative of a plurality of positions of the mobile device. Typically the location data is (and thus the one or more determined patterns of movement are) time referenced. The step of obtaining location data indicative of a plurality of positions of the mobile device may comprise obtaining said location data indicative of a plurality of positions of the mobile device during a (first) time period (e.g. 24 hours). Obtaining location data indicative of a plurality of positions of the mobile device during a time period may comprise tracking the position of the mobile device over that time period.

The step of obtaining location data indicative of a plurality of positions of the mobile device may further comprise obtaining said location data indicative of a plurality of positions of the mobile device during each of a plurality of time periods (e.g. such as a first 24 hour period and a second 24 hour period following the first 24 hour period).

The step of determining one or more patterns of movement of the device may include taking into account time references associated with the location data to determine one or more time referenced patterns of movement of the device. By “time referenced patterns of movement of the device”, we mean patterns of movement repeated by the device at particular times (e.g. times of day, days of the week, days of the month and/or months of the year) typically following a recognisable pattern.

The method may comprise determining from the said location data one or more base locations, each of the said base locations comprising a position or geographical area at which the device is located for a period of time greater than a base threshold time period (e.g. 1 hour or 5 hours), for example on one day or on a plurality of days, or on each day of a plurality of consecutive days. The location data relating to each of a plurality of time periods may be compared to determine one or more verified base locations, the verified base locations being base locations in common between two or more (or all of) the said time periods.

The method may comprise determining from the location data one or more routes followed by the device. The method may comprise determining two or more routes followed by the device. The method may comprise comparing the said two or more routes to determine one or more repeated routes of the device. Accordingly, the one or more patterns of movement may comprise one or more repeated routes of the device. The method may comprise comparing times associated with each instance of the repeated routes to determine one or more time referenced repeated routes of the device. Typically, the method comprises determining one or more repeated routes of the device by comparing routes followed by the device in each of two or more of the said plurality of time periods and determining routes in common between the two time periods.

By a “route” we mean a plurality of positions between a first position and a second position or between a first geographical region and a second geographical region.

By “repeated route” we mean a route followed by the device a number of times exceeding a repeated route threshold number of times. It may be that, between instances of the repeated route followed by the device, the device follows a different route or occupies one or more positions not on the repeated route. In order for a route to be recognised as a repeated route, it may be that only the first and second positions or first and second regions must match. Alternatively, it may be that one or more (or all) of the positions between the first and second positions or regions must also match.

One or more of the said patterns of movement may comprise one or more repeated positions of the device. A “repeated position of the device” may be a position which has been visited by the device a number of times exceeding a repeated position threshold number of times (optionally within a particular time period). Accordingly, the method may further comprise determining from the said location data one or more repeated positions of the device (e.g. positions occupied by the device more than once during a single time period, or during each of a plurality of time periods or during each of a plurality of consecutive time periods).

The method may comprise storing the said patterns of movement of the device in a patterns database (which is itself stored in a memory, e.g. of a server). The data representing the said patterns of movement of the device is typically time referenced, the time reference indicating a time (e.g. time of day, day of the week/month, month of the year) at which the pattern of movement is typically followed by the device. The said time reference is typically obtained from time references associated with the location data. The data representing the said patterns of movement is also typically associated with a user of the device, or with a device ID. The data representing the patterns of movement of the device may also be position referenced, the position reference indicating one or more positions or geographical areas associated with the pattern of movement of the device.

It may be that the user chooses from two or more transportation options when acting in accordance with an activity pattern starting from a base location, and that the selected mode of transport affects how far the device can travel from the base location to act in accordance with the activity pattern. For example, to act in accordance with an activity pattern, the user may occasionally drive or walk. Accordingly, the method may further comprise associating two or more geographical regions around the base location with one or each of one or more determined activity patterns of the device, the geographical regions being indicative of a potential range of movement of the device for the user to act in accordance with the activity pattern, each of the said regions may be associated with a different mode of transport. For example, for an activity pattern “buy lunch”, a first geographical region around the base location may be associated with the activity pattern which is representative of an anticipated potential range of movement of the device if the user is looking for lunch on foot and a second geographical region around the base location may be associated with the activity pattern which is representative of an anticipated potential range of movement of the device if the user is driving to obtain lunch. The method may comprise: determining a mode of transport of the device; selecting one of the said regions associated with the said activity pattern responsive to the determination of the mode of transport of the device; and selecting location specific data associated with the selected region. Accordingly, the location specific data portion output to the user interface may be selected responsive to how far a user of the device is able/willing to travel (e.g. from a base location) to act in accordance with an activity pattern. In order to determine which mode of transport is being taken (and therefore which region to select), the method may comprise tracking (e.g. a speed of) movement of the device. Additionally or alternatively, the mode of transport taken by the user may follow a particular pattern, in which case the method may comprise predicting from the location data which mode of transport is likely to be taken by the user at a particular time (e.g. time of day, day of the week/month, month of the year).

The method may further comprise categorising each of one or more estimated positions of the device and/or each of one or more routes followed by the device into a respective activity category (e.g. one of a plurality of activity categories). The method may further comprise categorising each of two or more positions of the device and/or each of two or more routes followed by the device (whether the routes are repeated routes or routes followed only once by the device) into a respective activity category. A position of, or route followed by, the device corresponding with a geographical feature, business or brand may be categorised into a respective activity category associated with that feature, business or brand. For example, if a position of the device corresponds with a position of a restaurant, that position may be categorised in a “restaurant” or “eatery” activity category. Additionally or alternatively, one or more activity categories may additionally or alternatively comprise an indication of a type of location area comprising the categorised position of the device and/or route followed by the device. For example, the activity category may comprise an indication that the position/route is in a city centre, a shopping area, a commercial area, a residential area or a retail area (and if it is a retail area, what the retail properties in the area sell, clothes, coffee and so on).

In order to categorise positions of, or routes followed by, the device, the said positions or routes may be compared to location specific geographical data from a database of location specific geographical data (e.g. mapping data comprising information regarding local businesses, public buildings, amenities such as train stations or bus terminals, roads, train lines, public parks/spaces and so on). The said database may be dynamically updated over time (e.g. with more businesses including entries in the database indicating their location and activity category). The activity category into which each of the said positions/routes are categorised may be selected from a plurality of predefined categories, or the activity category may be defined by the business itself. The said database of location specific geographical data may additionally or alternatively comprise data from or be in data communication with publically available mapping databases or location specific residential, business or retail directories.

The activity patterns may additionally or alternatively comprise one or more activity category patterns. The device may occupy a plurality of different positions over time, each of the said positions having activity categories in common. By recognising these common categories, activity patterns of the device can be determined even if the device does not follow any recognisable patterns of movement (but typically activity category patterns are determined together with patterns of movement of the device).

The method may further comprise determining one or more activity category patterns of the device by comparing the activity categories associated with position(s) of the device from the location data and/or associated with one or more routes followed by the device (or combinations of individual positions, regions and/or routes) and determining activity categories in common between positions/routes. The activity category patterns are typically indicative that the device regularly and/or frequently visits positions and/or geographical regions, and/or follows routes, having a particular activity category.

The method may further comprise taking into account the time references from the location data to determine one or more time referenced activity category patterns of the device. By “time referenced activity category patterns of the device” we mean patterns of positions of the device or routes followed by the device having particular activity categories at particular (and thus predictable) times (e.g. times of day, days of the week, days of the month and/or months of the year). The method may comprise comparing time references associated with each of the said position(s) of the device and/or one or more routes followed by the device. The two or more positions (or regions or routes) occupied (or followed) by the device from which the activity category patterns are determined may be from different respective time periods. The method may comprise determining one or more time referenced activity category patterns of the device by comparing activity categories associated with positions occupied and/or routes followed by the device in each of two or more of the said plurality of time periods and determining activity categories in common between the positions/routes. Typically, the said respective time periods (or times associated with the positions/routes having activity categories in common) follow a recognisable pattern. For example, it may be that the respective time periods all fall on Friday nights. Accordingly, the step of determining one or more activity category patterns of the device may comprise determining that two or more positions of the device from the said location data (and/or of two or more regions occupied by the device) and/or of two or more routes followed by the device (or combinations of individual positions, regions and/or routes) have one or more activity categories in common, the said two or more positions of the device (and/or of two or more regions occupied by the device) and/or of two or more routes followed by the device (or combinations of individual positions, regions and/or routes as appropriate) being time referenced to times or time periods following a recognisable pattern.

The data representing the said one or more activity patterns of the device may comprise one or more device parameters. The device parameters may comprise one or more natural language keywords representing one or more activity patterns of the device and/or one or more time references indicative of a time at which the device is likely to act in accordance with an activity pattern. Time references may be associated with one or more natural language keywords (e.g. the time period “weekends” may be associated with the keywords “sports fan”).

The method may further comprise prioritising the said selected location specific data portions in accordance with a or the determined relevance of the said location specific data portions to the mobile device. The method may further comprise outputting two or more (or all) of the location specific data portions in an order derived in accordance with the prioritisation of the said location specific data portions. The method may comprise assigning a higher priority to location specific data portions selected in response to data representing one or more activity patterns of the device meeting one or more relevance criteria of the said location specific data portions than, for example, location specific data portions selected in any other way (e.g. by determined relevance to one or more social profile parameters—see below). Typically, the higher priority location specific data portions are output to the user interface before the lower priority location specific data portions.

The method may further comprise allocating device parameters (e.g. natural language keywords) representing one or more activity patterns of the device with a confidence rating (e.g. score) indicative of a confidence level that the said parameter is relevant to the device. The confidence rating of one or more device parameters may be increased as the device approaches a particular position or geographical area associated with an activity pattern represented by the said device parameter(s) (and decrease as the device leaves a particular position or geographical area associated with an activity pattern represented by the said device parameter(s)) or be increased or decreased at particular times associated with an activity pattern represented by the said device parameter(s) (e.g. times of day, days of the week, days of the month, months of the year). Location specific data portions whose relevance criteria match data representing one or more activity patterns with a high confidence rating are typically provided with a higher priority than location specific data portions whose relevance criteria match data representing one or more activity patterns with a low confidence rating.

In some embodiments, the method comprises outputting to the user interface of the mobile device data from or associated with location specific data portions which have not been selected as a result of data representing one or more activity patterns of the device meeting one or more relevance criteria of the said location specific data portions. However, as above, the output to the user interface of data from or associated with location specific data portions selected as a result of data representing one or more activity patterns of the device meeting one or more relevance criteria of the said location specific data portions are typically given a higher priority.

The method may further comprise generating data representing one or more activity patterns of the device.

The method may comprise generating one or more device parameters.

The method may comprise generating one or more device parameters responsive to a determination of one or more activity patterns of the device. The method may comprise generating one or more natural language keywords representing an activity pattern taking into account a time reference indicative of a time at which the device is likely to act in accordance with the said activity pattern (e.g. if a pattern of movement comprising a route between a pair of train stations is derived from location data time referenced between 0700 and 0900 on weekdays, a natural language keyword “commuter” may be generated; if the same pattern of movement comprising a route between the said pair of train stations is derived from location data time referenced between 1000 and 1100 on weekends, the natural language keywords “day tripper” may be generated instead of “commuter”).

The method may comprise generating a device parameter (e.g. natural language keyword) in respect of an activity pattern (and optionally adding the generated device parameter to a user profile of the device). The said device parameter may comprise the name of an activity category associated with that activity pattern (e.g. the name of a or the common activity category of an activity category pattern associated with the device).

The method may comprise generating a device parameter (and optionally adding the generated device parameter to a user profile of the device) responsive to a user interaction with a location specific data portion which has been output to the user interface of the device. The method may comprise generating a device parameter (and optionally adding the generated device parameter to a user profile of the device) responsive to a user selecting a (or a feature of a) location specific data portion which has been output to the user interface of the device. The location specific data portion may contain an advertisement relating to a particular brand (or amenity or local business), and one or more keywords associated with the brand (or amenity or local business) may be added to the user profile responsive to the user's selection of the advertisement. The device parameter may be derived from the brand associated with the advertisement. In another example, the location specific data portion may contain an online auction, and the user may bid for a certain item. Natural language keywords associated with the said item may be derived (e.g. from the online auction) and (temporarily or permanently) added to the user profile. The device parameters may accordingly be selected from, or be associated with, the location specific data portion.

The data representing one or more activity patterns of the device may comprise one or more social parameters. Accordingly, the method may comprise determining one or more social parameters associated with the device. The method may comprise collecting (aggregating) user data. The method may comprise determining one or more social parameters from the collected user data. The method may comprise determining one or more patterns of movement of the device and/or one or more activity category patterns of the device taking into account the said user data (or data derived therefrom). The method may comprise taking into account the said collected user data when categorising one or more positions of the device and/or one or more routes followed by the device.

The step of determining one or more social parameters of the device may comprise determining one or more patterns in the user data. The method may further comprise generating one or more social parameters from the said one or more patterns in the user data.

The method may comprise sorting the user data (e.g. in chronological order, or by distance between a currently estimated position of the device and an estimated position of the device when the user data was entered by a user).

The user data may comprise, for example but not exclusively, one or more, or two or more, or three or more, selected from the following list: data from one or more social networking websites (e.g. blog posts, check-in location data, time reference data), data from one or more search engines (e.g. search terms), web browser data, message data (typically subject to permissions set by a user of the device), data relating to requests for positioning data.

It will be understood that the one or more parameters derived from the collected user data are typically associated with a user associated with the device.

It will be understood that a social networking website is a website which allows users to create profiles for, and connect with, persons or businesses, to post messages, and to share said messages with profiles to which the user is connected (and/or to other users of the website). Social networking websites may also allow users to (e.g. manually) “check-in” with their current location and/or to manually enter further details about themselves or others to whom they are connected. Data entered by users to such websites may be time referenced.

One or more social parameters may be associated with a time at which the data acquired from one or more social networking websites was input to the social networking websites.

The said one or more social parameters may comprise one or more natural language keywords. The method may comprise comparing collected user data with a keywords database. The method may further comprise recognising matches between collected user data and keywords from the keywords database and adding the matching keywords (permanently or, more typically, temporarily) to the user profile.

The method may further comprise: selecting a location specific data portion from the one or more location specific data portions responsive to a determination that one or more of the social profile parameters meet one or more relevance criteria associated with the said location specific data portion; and outputting to the user interface data from the selected location specific data portion or data associated with the selected location specific data portion. The method may further comprise (typically prior to the step of selecting a location specific data portion from the said one or more location specific data portions): determining a relevance to the mobile device of each of one or more location specific data portions by determining whether one or more social parameters (e.g. natural language keywords) of or associated with (a user of) the device meet one or more relevance criteria associated with the respective location specific data portions.

The method (e.g. the step of determining a relevance to the mobile device of each of one or more location specific data portions by determining whether the said data representing the said one or more activity patterns of the device meet one or more relevance criteria associated with the respective location specific data portions) may further comprise: comparing one or more device parameters to one or more relevance parameters associated with one or more location specific data portions and selecting a location specific data portion from the one or more location specific data portions responsive to a determination that one or more of the said one or more device parameters matches one or more relevance parameters associated with the said location specific data portion.

The step of selecting a location specific data portion from the one or more location specific data portions responsive to a determination that the said data representing the said one or more of the activity patterns meet one or more of the relevance criteria of the said location specific data portion may comprise: selecting a location specific data portion from the one or more location specific data portions responsive to a determination that one or more of the said one or more device parameters meet one or more (or all) of the relevance criteria of the said location specific data portion.

The step of generating one or more device parameters representing one or more of activity patterns of the mobile device may comprise receiving one or more device parameters from a manual user input. A user may wish to seek advertisements or offers relating to a particular product (e.g. coffee discounts) and so may wish to add coffee related parameters to the mobile device. For example, the user may enter a natural language keyword “coffee” in this instance.

The data representing one or more activity patterns of the device may be dynamically updated in use. For example, the method may comprise determining that the device has a new activity pattern and/or that it no longer follows an existing activity pattern. In the former situation, the method may comprise generating data representing one or more new activity patterns of the device and adding it to the user profile. In the latter situation, the method may comprise removing data representing one or more activity patterns of the device from the user profile.

Accordingly, the method may further comprise, after the step of outputting to the user interface data from the selected location specific data portion or data associated with the selected location specific data portion: determining one or more new (e.g. activity patterns not currently stored in the patterns database) activity patterns of the mobile device; generating data representing the said one or more new activity patterns of the mobile device; selecting a location specific data portion responsive to a determination that the data representing one or more of the new activity patterns meet one or more relevance criteria associated with the said location specific data portion; and outputting to the user interface data from or associated with the selected location specific data portion. The method may further comprise (typically between the steps of generating data representing the said one or more new activity patterns of the mobile device and selecting a location specific data portion responsive to a determination that the data representing one or more of the new activity patterns meet one or more relevance criteria associated with the said location specific data portion): determining a relevance to the mobile device of one or more location specific data portions by determining whether the data representing the said one or more new activity patterns of the device meet one or more relevance criteria associated with the said location specific data portions. As above, the step of generating data representing the said one or more new activity patterns of the device may comprise generating one or more device parameters. The new activity patterns may comprise patterns of movement of, or activity category patterns associated with, the device. Additionally or alternatively, the step of generating data representing the said one or more new activity patterns of the device may comprise receiving new user input data and/or generating one or more new social parameters.

The method may further comprise, after the step of outputting to the user interface data from the selected location specific data portion or data associated with the selected location specific data portion: acquiring new user data; and generating one or more new social parameters from the acquired new user data. The method may further comprise selecting a location specific data portion from the one or more location specific data portions responsive to a determination that one or more of the new social parameters meet one or more of the relevance criteria associated with the said location specific data portion; and outputting to the user interface data from the selected location specific data portion or data associated with the selected location specific data portion. The method may further comprise (prior to the step of selecting a location specific data portion from the one or more location specific data portions) determining whether the said one or more new social parameters meet one or more relevance criteria associated with the respective location specific data portions.

The relevance criteria of a location specific data portion may comprise a match between one or more of the said one or more device and/or social parameters and one or more corresponding relevance parameters associated with the said location specific data portion.

The said one or more relevance parameters may comprise one or more natural language keywords. The said natural language keywords may relate to the subject matter (e.g. subject matter type such as advertisement, train time table, online auction item etc.) of the data contained within that location specific data portion and/or a particular type of user (commuter, sports fan) who may be interested in the contents of the said location specific data portion.

In some embodiments one or more device parameters may be generated and/or added to the user profile responsive to a determination that the mobile device is not following an expected activity pattern of the device. In this case, a last known location of the device may be used to determine one or more device parameters. For example, if the mobile device does not follow an anticipated “commuting” pattern within a particular time period on a particular day, and the last known location of the device is at a base location (such as the user's home), keywords “off day” may be generated. In another example, if a last known location of the mobile device is in another country (e.g. at a tourist destination), a keyword “holiday” may be generated.

It will also be understood that (typically temporary) device parameters may be generated and/or added to the user profile in response to a position/geographical region of the device (or a route followed by the device), even if it does not fall under a particular pattern of activity (e.g. pattern of movement or activity category pattern).

These (typically temporary) device parameters may be used to select location specific data portions for output to the user interface of the mobile device.

The method may comprise: determining that the device is located at a position, or in a geographical area, at which it has never previously been located (or at which it rarely visits); selecting a location specific data portion associated with that position or geographical area; and outputting data from or associated with the selected location specific data portion to the user interface of the mobile device. Additionally or alternatively, the method may comprise: determining that the device is located at a position, or in a geographical area, at a time (or during a time period) at which it has never (or rarely) previously been located at that position or in that area (e.g. if the device is at a location it rarely visits or has never previously visited or rarely visits at lunchtime, the location specific data portion may comprise one or more advertisements of eateries in or adjacent to the area which are open for lunch). The method may comprise: determining that the device is located at a position, or in a geographical area which is indicative that the device is breaking an activity pattern which it has previously followed; and outputting data from or associated with the said selected location specific data portion to the user interface of the device. The determination that an activity pattern which has previously been followed is being broken may take into account the time (e.g. time of day). It will be understood that the selected location specific data portions are, in each case, typically relevant to the position of the device. Alternatively, the selected location specific data portions may be associated with a location which is not relevant to the current position of the device but is relevant to a location or category (e.g. activity category) of a location where the device would be been had it followed the broken activity pattern.

The method may further comprise (dynamically) amending (e.g. updating) one or more of the said location specific data portions. Typically the method further comprises outputting one or more amended (updated) location specific data portion(s) to the user interface of the device.

The method may further comprise (dynamically) updating one or more of the said location specific data portions responsive to an estimated position, or a sequence of estimated positions, of the device. Typically, the method comprises outputting to the user interface data from or associated with the selected location specific data portion, determining a change in the estimated position of the device, amending (updating) the selected location specific data portion responsive to the said determination of a change in the estimated position of the device, and outputting to the user interface data from or associated with the amended (updated) location specific data portion. The change in position of the device may be indicative that the device is entering or leaving a particular geographical region (which may contain a particular geographical feature, for example).

The method may further comprise: obtaining a first set of positioning data indicative of one or more first estimated positions of the device; comparing the said first set of positioning data to a position associated with the said data representing the said activity patterns of the device; performing the said step of outputting to the user interface data from the selected location specific data portion or data associated with the location specific data portion; obtaining a second set of positioning data indicative of one or more second estimated positions of the device; and amending (e.g. updating) the said location specific data portion responsive to the second set of positioning data. The location specific data portion may be amended responsive to the second set of positioning data indicating that the device is leaving a particular geographical region (e.g. without having visited a particular building, amenity, premises, business or other area within the region). The method may further comprise outputting the amended location specific data portion to the user interface of the mobile device.

For example, the first set of positioning data may be indicative that a user is approaching a region containing a local business which has produced a location specific data portion (comprised within the said plurality of location specific data portions) containing an advertisement that is relevant to the mobile device. The location specific data portion may be selected and output to the device in accordance with the above described method. It may be that the second set of positioning data is indicative that the user is leaving the region containing that local business (e.g. having not visited the said local business). Accordingly, the advertisement in the location specific data portion may be amended (updated) to offer a (larger) discount on one or more products mentioned in the original advertisement.

The method may further comprise (dynamically) updating one or more of the said location specific data portions responsive to time. For example, the method may comprise (dynamically) updating one or more of the said location specific data portions responsive to a time of day, a day of the week, a month of the year, the year and so on. Typically, the method comprises outputting to the user interface data from or associated with the selected location specific data portion, determining a change in time (e.g. a threshold time), amending (updating) the selected location specific data portion responsive to the said determination of a change of time, and outputting to the user interface data from or associated with the amended (updated) location specific data portion.

The method may further comprise (dynamically) updating one or more of the said location specific data portions responsive to a user interaction with the said location specific data portion(s). For example, the said location specific data portion(s) may comprise an internet auction site on which a user can input a bid. The said location specific data portion may be updated responsive to the said bid. Typically, the method comprises outputting to the user interface data from or associated with the selected location specific data portion, receiving an input from a user, amending (updating) the selected location specific data portion responsive to the said input, and outputting to the user interface data from or associated with the amended (updated) location specific data portion.

The method may further comprise transmitting data from or associated with one or more selected location specific data portions from the device to one or more further devices over an ad hoc network.

The ad hoc network may be a peer to peer network and may be facilitated by a Bluetooth connection or Wi-Fi connection (for example).

A second aspect of the invention provides data processing apparatus comprising:
a. a mobile device having a user interface;
b. a location specific database comprising one or more location specific data portions;
c. a user profile database containing at least one user profile comprising data representing one or more activity patterns of the mobile device;
d. a selection module configured to select a location specific data portion from the location specific database responsive to a determination that data representative of one or more of the activity patterns meet one or more relevance criteria associated with the said location specific data portion; and
e. an output module configured to output data from the selected location specific data portion(s) or data associated with the selected location specific data portions to the user interface of the mobile device.

The apparatus may comprise a relevance module configured to determine whether the data representing the said one or more activity patterns meet one or more relevance criteria associated with the one or more respective location specific data portions in order to determine a relevance to the mobile device of each of the one or more location specific data portions.

It will be understood that any or any combination of the location specific database, user profile database, relevance module and/or selection module may be provided on a server in data communication with the mobile device or in the mobile device itself. Accordingly the data processing apparatus typically comprises a server in data communication with the mobile device. The output module is typically provided on the mobile device.

The location specific data portions in the location specific database may be organised into categories. The selection module may be configured to receive a selection of one or more location specific data portion categories (e.g. from the mobile device). The selection module may be configured to select a location specific data portion from one of the one or more selected location specific data portion categories (and not typically from unselected location specific data portion categories). For example, the location specific data portions in the location specific database may comprise advertisements from a first source and advertisements from a second source. The advertisements from the first source may be categorised in a first location specific data portion category and the advertisements from the second source may be categorised into a second location specific data portion category. Following receipt of a selection of the first location specific data portion category, the selection module may be configured to select an advertisement from the said selected, first location specific data portion category (and not typically selecting an advertisement from the second, unselected location specific data portion category).

Preferably the data processing apparatus (and more preferably, the mobile device) further comprises a positioning module configured to estimate a position of the device. The server (e.g. a parameter generation module of the server) is typically configured to (e.g. temporarily) add to the user profile data representing one or more activity patterns of the device responsive to a determination by the positioning module that the mobile device is at or is approaching a position associated with the said activity pattern(s).

The data processing apparatus preferably further comprises a timing module configured to determine a current time, wherein the output module is configured to add to the user profile data representing one or more activity patterns of the device responsive to a determination by the timing module that the current time matches a time associated with the said activity pattern(s). The timing module is typically provided on the mobile device but may alternatively be provided on a or the server.

In some embodiments, the selection module is provided on the server and the server is configured to transmit the data from the selected location specific data portion or data associated with the selected location specific data portion to the mobile device (e.g. over a data communications network, such as a 2.5G, 3G, 4G mobile communications network, or the internet (e.g. via one or more Wi-Fi Access Points)).

The server may be configured to transmit data from the selected location specific data portion or data associated with the selected location specific data portion to the mobile device in response to a request received by the server from the mobile device. Alternatively, the server may be configured to transmit (“push”) the data from the selected location specific data portion or data associated with the selected location specific data portion to the mobile device automatically/autonomously (i.e. without having to receive a request from the mobile device). The server may be configured to transmit (“push”) the data from the selected location specific data portion or data associated with the selected location specific data portion to the mobile device responsive to a determination that the data representing one or more activity patterns of the mobile device meet one or more relevance criteria associated with the said location specific data portion. Additionally or alternatively, the server may be configured to transmit (“push”) the data from the selected location specific data portion or data associated with the selected location specific data portion to the mobile device at one or more particular times (e.g. at one or more times associated with the said location specific data portion and/or at one or more times associated with one or more of the said one or more activity patterns of the mobile device and/or at one or more times when a time associated with the said location specific data portion matches a time associated with one or more of the said one or more activity patterns of the device). Additionally or alternatively, the server may be configured to transmit (“push”) the data from the selected location specific data portion or data associated with the selected location specific data portion to the mobile device responsive to a determination that the mobile device is at a particular position or in a particular geographical region (e.g. a position or geographical region associated with the said location specific data portion and/or with one or more of the said one or more activity patterns of the device) or that the mobile device is approaching a particular position or geographical region (e.g. a position or geographical region associated with the said location specific data portion and/or with one or more of the said one or more activity patterns of the device) or that the mobile device is moving away from a particular position or geographical region (e.g. a position or geographical region associated with the said location specific data portion and/or with one or more of the said one or more activity patterns of the device).

In some embodiments, the selection module may be configured to select a location specific data portion from location specific database in response to a request received from the mobile device. Alternatively, the server may be configured to select a location specific data portion from location specific database automatically/autonomously (i.e. without having to receive a request from the mobile device). For example, the selection module may be configured to select a location specific data portion from the location specific database at regular or irregular time periods. Additionally or alternatively the selection module may be configured to select a location specific data portion from one or more location specific data portions at one or more particular times (e.g. at one or more times associated with the said location specific data portion and/or at one or more times associated with one or more of the said one or more activity patterns of the mobile device and/or at one or more times when a time associated with the said location specific data portion matches a time associated with one or more of the said one or more activity patterns of the device) or responsive to a determination that the mobile device is at a particular position or in a particular geographical region (e.g. a position or geographical region associated with one or more of the said one or more activity patterns of the device and/or associated with the said location specific data portion) or that the mobile device is approaching a particular position or geographical region (e.g. a position or geographical region associated with one or more of the said one or more activity patterns of the device and/or associated with the said location specific data portion) or that the mobile device is moving away from a particular position or geographical region (e.g. a position or geographical region associated with one or more of the said one or more activity patterns of the device and/or associated with the said location specific data portion).

The positioning module is typically configured to provide location data indicative of a plurality of estimates of position of the device (and for example transmit the position estimates to a or the server). The location data may comprise a plurality of time referenced estimates of the position of the device.

The data processing apparatus may further comprise: a pattern identification module in data communication with the positioning module for determining one or more activity patterns from location data obtained from the positioning module.

The pattern identification module may be configured to track the position of the mobile device by receiving a plurality of estimates of the position of the device from the positioning module. Typically the pattern identification module tracks the position of the mobile device for one or more time periods. The time periods may be of predetermined or adjustable duration.

One or more of the activity patterns may be, for example, patterns of movement of the device. In this case, the pattern identification module is typically configured to determine one or more patterns of movement of the device. The patterns of movement of the device may include repeated positions of, or routes followed by the device. Typically the pattern identification module determines routes followed by the device by determining one or more repeated sequences of positions of the device. The patterns of movement of the device may include one or more “base locations” being positions of the device which the device occupies for a (typically continuous) time period of duration exceeding a base location time threshold value on one or a plurality of (e.g. consecutive) days (or a geographical area which the device is positioned within for a time period of duration exceeding a base location threshold value on one or a plurality of, e.g. consecutive, days). The pattern identification module may determine one or more patterns of movement of the device taking into account the said time references to determine one or more time referenced patterns of movement of the device. By “time referenced patterns of movement of the device”, we mean repeated positions of, or routes followed by the device at particular times (e.g. times of day, days of the week, days of the month and/or months of the year). The patterns of movement are typically location specific.

The activity patterns may comprise one or more activity category patterns. Accordingly, the pattern identification module may be configured to determine one or more activity category patterns of the device. In this case, the pattern identification module may be configured to categorise one or more (preferably all of the) time referenced positions from the location data into a respective activity category. The pattern identification module may additionally or alternatively be configured to identify one or more routes followed by the device and categorise the said one or more routes into one of a plurality of activity categories. The pattern identification module may be further configured to compare the categories of the time referenced positions and/or routes of the device and determine one or more activity category patterns of the device by identifying activity categories in common between the positions/routes of the device. The pattern recognition module may be configured to take into account the time references to determine one or more time referenced activity category patterns of the device. By “time referenced activity category patterns of the device” we mean positions of the device or routes followed by the device having particular activity categories at particular times (e.g. times of day, days of the week, days of the month and/or months of the year).

The data representing one or more activity patterns of the device may comprise one or more social parameters. The data processing apparatus may further comprise an aggregator for collecting user data (typically relating to the use of the mobile device by a user). The pattern identification module may be configured to sort the user data (e.g. chronologically). The parameter generation module may be operable to determine one or more social parameters from the (sorted) collected user data.

The parameter generation module may be configured to determine one or more device parameters from the activity patterns of the user.

The data processing apparatus may further comprise a parameter generation module in data communication with the pattern identification module for generating data representing one or more activity patterns of the device determined by the pattern identification module.

The pattern identification module and parameter generation modules may be provided on the mobile device, but more preferably the pattern identification module and parameter generation modules are provided on a server computer.

The data representing one or more activity patterns of the device may comprise one or more social parameters. The data processing apparatus may further comprise an aggregator for collecting user data. The pattern identification module may be configured to sort the user data (e.g. chronologically). The parameter generation module may be operable to determine one or more social parameters from the (sorted) collected user data.

The parameter generation module may be operable to determine one or more social parameters from the collected user data and/or from the patterns determined by the pattern identification module.

The pattern identification module may take into account the said user data (or data derived therefrom) when determining one or more activity patterns of the device.

The data processing apparatus may further comprise a user profile database comprising one or more user profiles storing data representing one or more activity patterns of the device. The parameter generation module is typically in data communication with the user profile database, data being generated by the parameter generation module being retrievably storable in a user profile of the user profile database.

Data representing one or more activity patterns of the device may be permanently or temporarily stored in the user profile. Additionally, the data processing apparatus may further comprise a patterns database in which data representing one or more activity patterns may be stored. In this case, the data stored in the patterns database may be time referenced to a time and/or a position of the device at which the data representing one or more activity patterns of the device may be relevant to the device. The parameter generation module may be configured to dynamically add to or remove from the user profile data representing one or more activity patterns of the device responsive to a determination that a position of the device matches or no longer matches a position of the device stored in the patterns database and associated with the said one or more activity patterns. Additionally or alternatively, the parameter generation module may be configured to dynamically add to or remove from the user profile data representing one or more activity patterns of the device responsive to a determination that a time associated with a request made by the mobile device matches or no longer matches time data associated with data representing the said one or more activity patterns from the patterns database.

The request may be an explicit request for a location specific data portion. Alternatively, the request may be an implicit request for location specific data portions (e.g. data transmitted to the server which is interpreted by the server as such a request, the said data not explicitly requesting a location specific data portion from the server). The request may for example be data representing an estimated position of the device which is interpreted by the server as a request for one or more location specific data portions.

The selection module may be configured to: obtain data from the dynamically updated data representing one or more activity patterns associated with the device from the user profile; and to select a location specific data portion from the location specific database responsive to a determination that the data from the dynamically updated data representing one or more of the one or more activity patterns meet one or more relevance criteria associated with the said location specific data portion.

The method may comprise outputting data to the user interface of the device responsive to determination that an activity pattern which has previously been followed is being broken, or has been broken. The determination that an activity pattern which has previously been followed is being broken, or has been broken, may take into account the time (e.g. time of day). The data which is output to the user interface may be data from or associated with a location which is not relevant to the current position of the device but is relevant to a location or category (e.g. activity category) of a location where the device would be been had it followed the broken activity pattern.

A third aspect of the invention provides a method of generating data representing one or more activity patterns of a mobile device, the method comprising: obtaining location data indicative of a plurality of locations of the mobile device; determining from the location data one or more activity patterns of the device; and generating one or more device parameters representing the said one or more activity patterns.

The location data may comprise a plurality of time referenced estimates of the position of the device.

One or more of the activity patterns may be, for example, patterns of movement of the device. In this case, the method may comprise identifying one or more patterns of movement of the device. The patterns of movement of the device may include repeated positions of, or routes followed by the device. Typically the routes followed by the device are determined by identifying one or more repeated sequences of positions of the device. The patterns of movement of the device may include one or more “base locations” being repeated positions of the device which the device occupies for a time period of duration exceeding a base location time threshold value (or a geographical area which the device is positioned within for a time period of duration exceeding a base location threshold value). The step of identifying one or more patterns of movement of the device may include taking into account the said time references to determine one or more time referenced patterns of movement of the device. By “time referenced patterns of movement of the device”, we mean repeated positions of, or routes followed by the device at particular times (e.g. times of day, days of the week, days of the month and/or months of the year). The patterns of movement are typically location specific.

One or more of the activity patterns may be, for example, activity category patterns of the device. In this case, the method may comprise categorising one or more time referenced positions from the location data into one of a plurality of activity categories. The method may additionally or alternatively comprise identifying one or more routes followed by the device and categorising the said one or more routes into one of a plurality of activity categories. The method may further comprise comparing the categories of the time referenced positions and/or routes of the device and determining one or more activity category patterns of the device by identifying activity categories in common between the positions/routes of the device. The method may further comprise taking into account the time references to determine one or more time referenced activity category patterns of the device. By “time referenced activity category patterns of the device” we mean positions of the device or routes followed by the device having particular activity categories at particular times (e.g. times of day, days of the week, days of the month and/or months of the year).

The step of obtaining location data indicative of a plurality of locations of the mobile device may comprise tracking the position of the mobile device.

Typically the position of the mobile device is tracked for one or more time periods. The time periods may be of predetermined or adjustable duration.

Tracking a position of the device may comprise receiving (e.g. at a server) a plurality of estimated positions of the device from a positioning module (e.g. a positioning module of the device).

The data representing one or more activity patterns of the device may comprise one or more device parameters. The said one or more device parameters may comprise one or more natural language keywords associated with the one or more determined activity patterns of the device.

The one or more device parameters may comprise a time reference associated with a determined pattern of movement, the time reference being indicative of a time at which the device is likely to follow the said pattern of movement.

The time reference may be (for example) a time of day and/or a day of the week and/or a group of days of the week (e.g. weekend, weekday). For example, a commuter may only commute from Monday to Friday. In this case, the group of days Monday to Friday may be associated with the “commuting” pattern of movement of the device. In this case, the “commuting” pattern of movement may only be selected on those days.

The time reference may be an absolute time (e.g. 0800 on a given day or group of days). Alternatively the time reference may be a time period (e.g. any time between Monday and Friday).

Device parameters (e.g. natural language keywords) generated in respect of an activity pattern may comprise the names of one or more activity categories (e.g. the name of a or the common activity category of an activity category pattern), geographical features, amenities, businesses or brands associated with one or more patterns of movement of the device. Natural language keywords may be generated from an activity category of one or more patterns of movement, or a common activity category of one or more activity category patterns.

The method may further comprise generating one or more device parameters taking into account a time associated with one or more of the activity patterns of the device.

The data representing one or more activity patterns of the device may comprise one or more social parameters. Accordingly, the method may comprise determining one or more social parameters. In some embodiments, the method may comprise collecting (aggregating) user data. The method may comprise determining one or more social parameters from the user data. The method may also comprise determining one or more patterns of movement of the device and/or one or more activity category patterns of the device taking into account the said user data (or data derived therefrom). The method may comprise taking into account the said user data when categorising one or more positions of the device and/or one or more routes followed by the device.

The step of determining one or more social parameters of the device may comprise determining one or more patterns in the user data. The method may further comprise generating one or more social parameters from the said one or more patterns in the user data.

The method may comprise sorting the user data (e.g. in chronological order, or by distance between a currently estimated position of the device and an estimated position of the device when the user data was entered by a user).

The user data may comprise, for example but not exclusively, one or more, or two or more, or three or more, selected from the following list: data from one or more social networking websites (e.g. blog posts, check-in location data, time reference data), data from one or more search engines (e.g. search terms), web browser data, message data (typically subject to permissions set by a user of the device), data relating to requests for positioning data.

It will be understood that the one or more parameters derived from data collected from one or more social networking websites are typically associated with a user associated with the device.

One or more social profile parameters may be associated with a time at which the data acquired from one or more social networking websites was input to the social networking websites.

The method may comprise storing the data representing one or more activity patterns of the device in a user profile of the device. Data representing one or more activity patterns of the device may be permanently or temporarily stored in the user profile. Additionally, data representing one or more activity patterns may be stored in a patterns database. In this case, the data stored in the patterns database may be time referenced to a time and/or a position of the device at which the data representing one or more activity patterns of the device may be relevant to the device. The method may comprise dynamically adding to or removing from the user profile data representing one or more activity patterns of the device responsive to a determination that a position of the device matches or no longer matches a position of the device stored in the patterns database and associated with the said one or more activity patterns. Additionally or alternatively, the method may comprise dynamically adding to or removing from the user profile data representing one or more activity patterns of the device responsive to a determination that a time associated with a request made by the device matches or no longer matches time data associated with data representing the said one or more activity patterns from the patterns database.

The parameter generation module may allocate device parameters (e.g. natural language keywords) representing one or more activity patterns of the device a (typically updateable) confidence rating (e.g. score) indicative of a confidence level that the said parameter is relevant to the device. The parameter generation module may be configured to increase the confidence rating of one or more device parameters as the device approaches a particular position or geographical area associated with an activity pattern represented by the said device parameter(s) (and decrease the confidence rating as the device 1 leaves a particular position or geographical area associated with an activity pattern represented by the said device parameter(s)) or increase or decrease the confidence rating at particular times associated with an activity pattern represented by the said device parameter(s) (e.g. times of day, days of the week, days of the month, months of the year).

A fourth aspect of the invention provides data processing apparatus comprising:
a. a mobile device;
b. a positioning module configured to obtain location data indicative of a plurality of positions of the mobile device;
c. a pattern identification module in data communication with the positioning module for determining one or more activity patterns from location data obtained from the positioning module; and
d. a parameter generation module in data communication with the pattern identification module for generating data representing one or more activity patterns of the device determined by the pattern identification module.

The positioning module is typically provided on the mobile device. The pattern identification module and parameter generation modules may be provided on the mobile device, but more preferably the pattern identification module and parameter generation modules are provided on a server computer in data communication with the mobile device.

The location data may comprise a plurality of time referenced estimates of the position of the device.

The pattern identification module may be operable to track the position of the mobile device by receiving a plurality of positions from the positioning module. Typically the pattern identification module tracks the position of the mobile device for one or more time periods. The time periods may be of predetermined or adjustable duration.

One or more of the activity patterns may be, for example, patterns of movement of the device. In this case, the pattern identification module is configured to determine one or more patterns of movement of the device. The patterns of movement of the device may include repeated positions of, or routes followed by the device. Typically the pattern identification module determines routes followed by the device by determining one or more repeated sequences of positions of the device. The patterns of movement of the device may include one or more “base locations” being positions of the device which the device occupies for a (typically continuous) time period of duration exceeding a base location time threshold value on one or a plurality of (e.g. consecutive) days (or a geographical area which the device is positioned within for a time period of duration exceeding a base location threshold value on one or a plurality of, e.g. consecutive, days). The pattern identification module may determine one or more patterns of movement of the device taking into account the said time references to determine one or more time referenced patterns of movement of the device. By “time referenced patterns of movement of the device”, we mean repeated positions of, or routes followed by the device at particular times (e.g. times of day, days of the week, days of the month and/or months of the year). The patterns of movement are typically location specific.

The activity patterns may comprise one or more activity category patterns. Accordingly, the pattern identification module may be configured to determine one or more activity category patterns of the device. In this case, the pattern identification module may be configured to categorise one or more (preferably all of the) time referenced positions from the location data into a respective activity category. The pattern identification module may additionally or alternatively be configured to identify one or more routes followed by the device and categorise the said one or more routes into one of a plurality of activity categories. The pattern identification module may be further configured to compare the categories of the time referenced positions and/or routes of the device and determine one or more activity category patterns of the device by identifying activity categories in common between the positions/routes of the device. The pattern recognition module may be configured to take into account the time references to determine one or more time referenced activity category patterns of the device. By “time referenced activity category patterns of the device” we mean positions of the device or routes followed by the device having particular activity categories at particular times (e.g. times of day, days of the week, days of the month and/or months of the year).

The data representing one or more activity patterns of the device may comprise one or more social parameters. The data processing apparatus may further comprise an aggregator for collecting user data (typically relating to the use of the mobile device by a user). The pattern identification module may be configured to sort the user data (e.g. chronologically). The parameter generation module may be operable to determine one or more social parameters from the (sorted) collected user data.

The parameter generation module may be configured to determine one or more device parameters from the activity patterns of the user.

The parameter generation module may be operable to determine one or more social parameters from the collected user data and/or from the patterns determined by the pattern identification module.

The pattern identification module may take into account the said user data (or data derived therefrom) when determining one or more activity patterns of the device.

The data processing apparatus may further comprise a user profile database comprising one or more user profiles storing data representing one or more activity patterns of the device. The parameter generation module is typically in data communication with the user profile database, data being generated by the parameter generation module being retrievable storable in a user profile of the user profile database.

Data representing one or more activity patterns of the device may be permanently or temporarily stored in the user profile. Additionally, the data processing apparatus may further comprise a patterns database in which data representing one or more activity patterns may be stored. In this case, the data stored in the patterns database may be time referenced to a time and/or a position of the device at which the data representing one or more activity patterns of the device may be relevant to the device. The parameter generation module may be configured to dynamically add to or remove from the user profile data representing one or more activity patterns of the device responsive to a determination that a position of the device matches or no longer matches a position of the device stored in the patterns database and associated with the said one or more activity patterns. Additionally or alternatively, the parameter generation module may be configured to dynamically add to or remove from the user profile data representing one or more activity patterns of the device responsive to a determination that a time associated with a request made by the device matches or no longer matches time data associated with data representing the said one or more activity patterns from the patterns database.

A fifth aspect of the invention provides a method of generating data representing one or more interests or habits of a user of a mobile device, the method comprising collecting (aggregating) user data relating to a user of a mobile device; determining one or more patterns in the user data; and determining one or more social parameters indicative of one or more interests or habits of the user from the patterns in the user data.

The user data may comprise, for example but not exclusively, one or more, or two or more, or three or more, selected from the following list: data from one or more social networking websites (e.g. blog posts, check-in location data, time reference data), data from one or more search engines (e.g. search terms), web browser data, message data (typically subject to permissions set by a user of the device), data relating to requests for positioning data.

The patterns in the user data may comprise repeated keywords and/or repeated positions of the device determined from the user data. The patterns in the user data may comprise repeated keywords referenced to times or estimated positions of the device. The patterns in the user data may comprise repeated positions of the device at times following a recognisable (repeated) pattern. The method may further comprise generating one or more social parameters from the said one or more patterns in the user data.

The method may comprise sorting the user data (e.g. in chronological order, or by distance between a currently estimated position of the device and an estimated position of the device when the user data was entered by a user). Typically the sorting step is performed prior to the parameter generation step.

It will be understood that the one or more parameters derived from data collected from one or more social networking websites are typically associated with a user associated with the device.

One or more social profile parameters may be associated with a time at which the data acquired from one or more social networking websites was input to the social networking websites.

The method may further comprise storing the social parameters in a user profile. The method may further comprise retrieving one or more social parameters from the user profile; selecting a location specific data portion from the one or more location specific data portions responsive to a determination that the one or more social parameters meet one or more relevance criteria of the said location specific data portion; and outputting to a user interface data of the mobile device data from the selected location specific data portion or data associated with the selected location specific data portion. The method may further comprise (typically between the steps of retrieving one or more social parameters from the user profile and selecting a location specific data portion from the one or more location specific data portions): determining a relevance to the mobile device of each of one or more location specific data portions by determining whether the said one or more social parameters meet one or more relevance criteria associated with the respective location specific data portions.

A sixth aspect of the invention comprises data processing apparatus comprising:
a mobile device;
an aggregator in data communication with the mobile device for collecting user data relating to a user of the mobile device (typically the user data relates to the user of the mobile device by the user);
a pattern recognition module in data communication with the aggregator for determining one or more patterns in the collected user data; and
a parameter generation module in data communication with the pattern recognition module for generating one or more social parameters indicative of the interests or habits of the user from the one or more patterns in the collected user data.

The aggregator may be provided on the mobile device or on a server in data communication with the user device. However, most preferably the aggregator is distributed on both the mobile device and on a server computer. The pattern recognition module and the parameter generation module may be provided in the mobile device, but more preferably in a or the server in data communication with the mobile device.

Although the embodiments of the invention described with reference to the drawings comprise methods performed by computer apparatus, and also computing apparatus, the invention also extends to program instructions, particularly program instructions on or in a computer readable storage medium, adapted for carrying out the processes of the invention or for causing a computer to perform as the computer apparatus of the invention. Programs may be in the form of source code, object code, a code intermediate source, such as in partially compiled form, or any other form suitable for use in the implementation of the processes according to the invention. The computer readable storage medium may be any tangible entity or device capable of carrying the program instructions.

For example, the computer readable medium may be a ROM, for example a CD ROM or a semiconductor ROM, or a magnetic recording medium, for example a floppy disc or hard disc.

Any of the methods described above may be computer implemented methods.

A further aspect of the invention provides a non-transitory computer readable medium retrievably storing computer readable code for causing a computer to perform the steps of the method according to the first, third or fifth aspects of the invention. It will be understood that the term “non-transitory computer-readable medium” comprises all computer-readable media, with the sole exception being a transitory, propagating signal.

The preferred and optional features discussed above are preferred and optional features of each aspect of the invention to which they are applicable. For the avoidance of doubt, the preferred and optional features of each aspect of the invention are also preferred and optional features of all of the other aspects of the invention, where applicable.

### DESCRIPTION OF THE DRAWINGS

An example embodiment of the present invention will now be illustrated with reference to the following Figures in which:

FIG. 1 is a schematic diagram showing a mobile device in electronic data communication with a server;

FIG. 2 is a flowchart illustrating a method of outputting location specific data to a user;

FIG. 3 is a flowchart illustrating a method of obtaining and processing feedback from a user regarding location specific data output to the mobile device;

FIG. 4 is a more detailed version of the diagram of FIG. 1, showing additional modules of the server and communication between the server and three social networking websites;

FIG. 5 is a flowchart illustrating a method of generating one or more parameters associated with one or more determined patterns of movement of the mobile device of FIGS. 1 and 4; and

FIG. 6 is a flowchart illustrating a method of determining social parameters associated with a user of the mobile device.

### DETAILED DESCRIPTION OF AN EXAMPLE EMBODIMENT

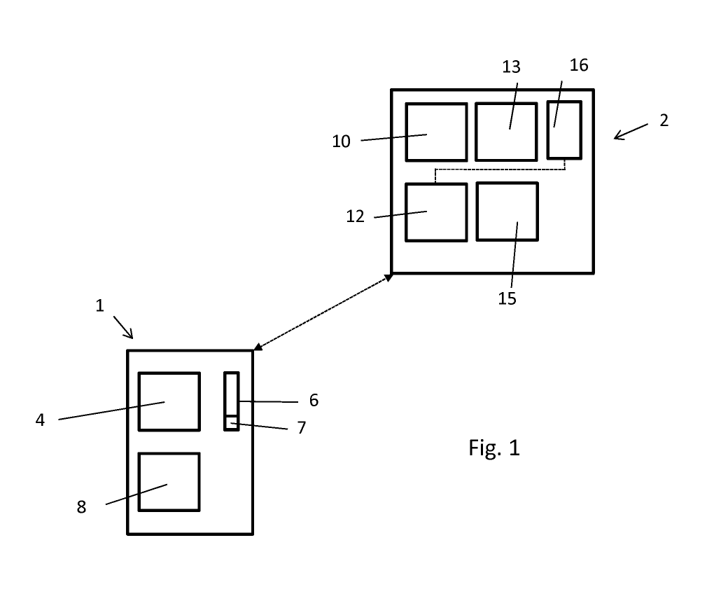

FIG. 1 is a schematic diagram of a mobile device 1 (such as a mobile smartphone or tablet computer) in electronic data communication (e.g. over a 2G, 2.5G, 3G or 4G cellular telephone network, or over the internet via for example a Wi-Fi connection) with a server 2. The mobile device 1 comprises a positioning module 4 which may be a satellite positioning module (e.g. a GPS module comprising a GPS receiver configured to receive satellite positioning signals from GPS satellites and a processor operable to process the satellite positioning signals to provide an estimate of the position of the device 1) for estimating the position of the device 1. However, it will be understood that any suitable positioning module could be used either in addition to the satellite positioning module or as an alternative thereto. For example, the positioning module may comprise an electromagnetic signal receiver operable to receive electromagnetic signals emitted by a plurality of electromagnetic signal sources of known location, and a processor operable to process the received signals together with the known locations of the signal sources to estimate the position of the device by, for example, triangulation.

The server 2 comprises a location specific database 10 storing a plurality of location specific data portions. The location specific data portions typically comprise media files (e.g. an image, video and/or audio file and/or a webpage) containing advertising data suitable for being output by the output module 7 of the software application 6 to a user interface 8 (e.g. screen, audio speakers and/or audio jack for outputting audio to ear/headphones) of the mobile device 1. The location specific data portions typically have (or are associated with) respective location specific data portion identifiers which can be used for identifying the location specific data portions. Each location specific data portion has one or more relevance parameters associated with it which can be used to determine the relevance of that location specific data portion to the device 1 (see below). Typically, the relevance parameters comprise data representing a respective location or geographical area, such as a position of (or a geographical area surrounding) a business premises with which advertising data in the location specific data portion is associated. As discussed below, this location/geographical area information allows data to be selected from a particular location specific data portion and output to the user interface 8 if, for example, the device 1 has an estimated position (e.g. by the positioning module 4) which is approaching, is in the vicinity of, or is at the location or geographical area with which the location specific data portion is associated.

The relevance parameters of one or more of the location specific data portions may also comprise (or be associated with) an activity category indicative of a type of activity associated with the data comprised in the location specific data portion and/or of a type of location area comprising the categorised position of the device and/or route followed by the device. For example a location specific data portion comprising an advertisement relating to a restaurant may be associated with a “restaurant” or “eatery” category, or a “city centre” category. As discussed below, this activity category information can be used to output targeted information to the user interface of the device 1.

The relevance parameters of one or more of the location specific data portions may further comprise one or more natural language keywords (or data representing one or more natural language keywords), the said natural language keywords relating to the subject matter (e.g. subject matter type such as advertisement, train time table, online auction item etc.) of the data contained within that location specific data portion and/or a particular type of user (commuter, sports fan) who may be interested in the contents of the said location specific data portion. For example, if a location specific data portion containing an advertisement is provided, one or more of the natural language keywords may comprise one or more of the following indicators: that the data portion contains an advertisement; an advertisement type (e.g. normal, special offer); and/or an indication of the type (e.g. holiday, car) of the product being advertised. If the advertisement is, for example, for a time limited special offer, the location specific data portion may also comprise or be associated with a “valid until” date comprising a date when the or each advertisement (and thus the offer) expires.

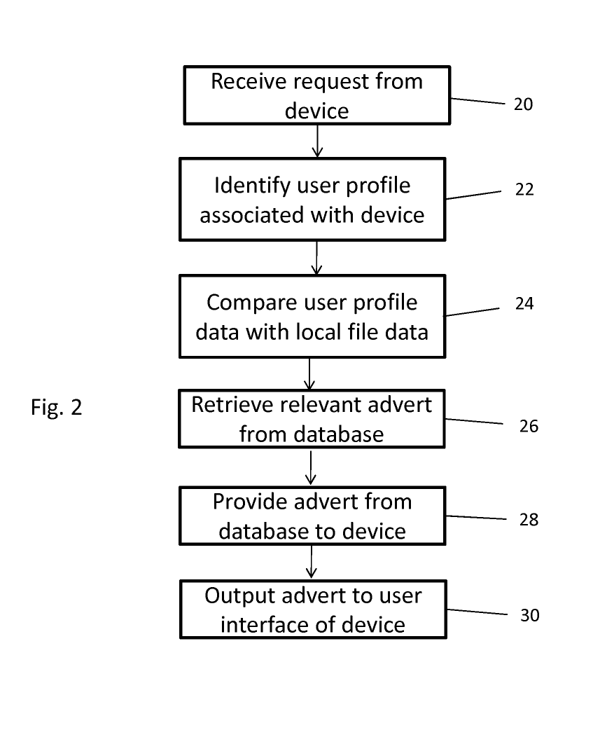

The mobile device 1 runs a software application 6 which is configured to request location specific data from the server 2 (although as outlined in the Summary of Invention above, the server 2 may alternatively be configured to automatically or autonomously “push” location specific data to the mobile device without having to receive a request from the mobile device 1). The software application may generate the requests responsive to user actions, or automatically (e.g. periodically or responsive to events, such as at a certain time). The server 2 receives the requests, processes them and selects data from one or more location specific data portions from the location specific database for output on the user interface 8 of the device 1. The software application 6 receives the selected data and an output module 7 of the application 6 outputs the selected data (or data stored on the mobile device 1 which is associated therewith) to the user interface 8. The way in which the server 2 processes requests from the mobile device 1 is now explained with reference to FIG. 2.

The server 2 receives a request from the mobile device 1 in a first step 20. The request contains an identifier of the device 1, which identifier is matched by the server 2 in a next step 22 to a device identifier stored in a user profile database 12 of the server 2 and associated with a user profile relating to a user of that device 1. The user profile database 12 typically further comprises a plurality of other user profiles which may be associated with the device 1 or more typically other such devices. The user profile comprises data representing one or more activity patterns of (a user of) the device 1. In a next step 24, a relevance module 13 of the server 2 compares the data representing one or more activity patterns of the device 1 to the relevance parameters of the location specific data portions of the location specific database in order to determine a relevance of the location specific data portions to the user interface of the device 1.

The activity patterns of the device 1 which the data in the user profile represent may comprise one or more patterns of movement of the device 1, such as positions or geographical areas regularly occupied by the device 1 (e.g. a location regularly visited by the device or one or more “base locations” of the device at which the device is located for a time period exceeding a base threshold time period) and/or repeated routes followed by the device. For example, a pattern of movement of the device may comprise a route regularly followed by the device 1 between two train stations. This pattern of movement may be directly associated with an activity of “commuting”. Accordingly, the data representing this activity pattern may comprise an indicator that the user is a “commuter”. In other examples, the patterns of movement of the device may be indicative that a user is a supporter of a particular sports team (e.g. if the device regularly occupies a position inside a particular stadium), that a user is a regular shopper at a particular store or mall (e.g. if the device is regularly positioned at the mall), etc, and the data representing the activity patterns associated with the device may reflect the user's patterns of attending sports events or the user's shopping habits respectively. Ways in which one or more patterns of movement of the device can be determined, and ways in which data representing patterns of movement of the device can be determined, are discussed below.

The activity patterns may additionally or alternatively comprise one or more activity category patterns. As will be explained in more detail below, positions occupied by the device (e.g. within a restaurant), or routes followed by the device (e.g. walking route from a “base location” (e.g. home) to a restaurant) may be categorised into a respective activity category. A plurality of positions/routes may have activity categories in common. Accordingly, by comparing activity categories of positions occupied by the device and/or routes followed by the device (see below for more detail), activity patterns associated with the device 1 can be determined (by identifying positions/routes having activity categories in common) even if the device 1 does not follow well defined patterns of movement.

It may be that some of the data representing one or more activity patterns of the device is permanently provided in the user profile, and/or it may be that data representing one or more activity patterns of the device is temporarily provided in the user profile. For example, there may be some activity patterns which are relevant of a general interest of a user of the device, in which case it is preferable that data representing those activity patterns are permanently provided in the user profile. However, it may be preferable that data representing one or more activity patterns is only temporarily provided in the user profile (e.g. during a time at which the user is expected to begin an activity, during the activity or when the device is expected to end an activity and/or when the device is in a location associated with the activity pattern).

The server 2 may further comprise a patterns database 16 which stores data relating to the activity patterns of the device. In order to determine when temporary data should be added to and removed from the user profile, the patterns database 16 may comprise time reference data relating to the time at which some or each of the activity patterns are typically followed by the device 1. For example, the time reference data may comprise data representing typical days of the week on which a particular pattern of movement is followed (e.g. Monday to Friday, or weekends). Additionally or alternatively, the time data may comprise particular times of day (e.g. 1-2 pm, 7.30-8.30 am, 8 pm) at which a particular activity is typically followed by the device 1. Typically, the user profile database 12 is in data communication with the patterns database 16, such that data representing activity patterns stored in the patterns database 16 can be added to and removed from user profiles at times specified in the patterns database 16. Thus, the time data can be used to define “sessions” during which data associated with an activity can be added to the user profile when it is most likely to be relevant and removed from the user profile when it is not likely to be relevant. Accordingly, an additional step of dynamically updating the user profile may be performed (e.g. between identifying the user profile and comparing user profile data with the relevance parameters of the location specific data portions), with temporary data representing one or more activity patterns of the user being removed from the user profile, and/or data representing one or more other activity patterns of the device being added to the user profile. Typically, the device 1 comprises a timing module 51 for determining an estimate of the current time, and the estimate of the current time provided by the timing module 51 is typically included in the request to the server 2 for location specific data.

The patterns database 16 may store position data relating to one or more of the activity patterns such as one or more locations such as the entrance to an amenity (such as a train station) or one or more particular geographical regions (e.g. a region surrounding a particular feature such as a sports stadium). Accordingly, the user profile may be dynamically updated to (e.g. temporarily) include data representing one or more of activity patterns when the device is estimated to be at or approaching a position associated with the said activity patterns (e.g. by the positioning module 4). In this case, it is preferable that a position of the device 1 estimated by the positioning module 4 is included in the request sent to the server 2. The said one or more locations or geographical regions associated with the activity patterns may be retrievably stored in the patterns database 16. The server 2 may compare the estimated position of the device 1 from the request to positions or geographical regions provided in the patterns database 16 to determine whether data representing the activity patterns should be added to the user profile. The server 2 may then update the user profile as appropriate when the estimated position of the device 1 matches (or no longer matches) a position or geographical region associated with an activity pattern.

The data representing the activity patterns in the user profile typically comprises one or more device parameters, such as natural language keywords, relevant to the said activity patterns. For example, if a repeated position of the device comprises a soccer stadium, a natural language keyword “soccer fan” may be provided in the user profile. As another example, if the said activity pattern relates to a commute between two locations, a natural language keyword “commuter” may be provided in the user profile. Device parameters, such as natural language keywords, may additionally or alternatively be input manually by the user.

The user profile may additionally comprise social profile data relating to a user of the device. The social profile data typically comprises one or more social parameters (e.g. natural language keywords) indicative of interests, approximate age and other social parameters of the user. Social parameters may be manually entered by the user (e.g. to the device and transmitted to the server for processing) or, as explained below, extracted by aggregating and mining user data (e.g. data from one or more social networking websites (e.g. blog posts, check-in location data, time reference data), data from one or more search engines (e.g. search terms), web browser data, message data and so on (typically subject to permissions set by a user of the device)).

It may be that the determination of the relevance of a location specific data portion to a device 1 by the relevance module 13 is a binary decision. That is, it may be determined that a location specific data portion is either relevant to the device 1 or that it is not. Alternatively, and more typically, the determination of relevance of a location specific data portion to a device provides each location specific data portion with a score along a relevance scale indicating a relevance of the location specific data portion to the device 1. For example, each location specific data portion may be allocated a score by the relevance module 13 depending on how closely the data representing the activity patterns match the relevance parameters and/or how many natural language keywords from the data representing the activity patterns match corresponding natural language keywords of the relevance parameters.

The server 2 further comprises a selection module 15 configured, in a next step 26, to retrieve data from or associated with the location specific data portions from the database 10 determined to be relevant (or most relevant) to the device by the relevance module 13. Typically, the selection module 15 also transmits the said retrieved data to the output module 7 (typically via a receiver module of the software application 6) of software application 6 for output to the user interface 8 in a next step 28. It may be that data from or associated with the location specific data portions is output to the user interface 8 of the device in order of determined relevance (priority) by the relevance module. For example, data from or associated with the location specific data portions with the highest relevance scores may be output to the user interface 8 first. Alternatively, only data from or associated with location specific data portions determined to be relevant to the mobile device 1 by the relevance module 13 may be output to the user interface 8, either in order of determined relevance or in any order. The data from or associated with the selected location specific data portion is output to the user interface 8 of the device 1 in a next step 30.

The data (e.g. natural language keywords) representing one or more activity patterns of the device may also be allocated a confidence rating (e.g. score) indicative of a confidence level that the said parameter is relevant to the device. For example, a score associated with a natural language keyword may be incremented to indicate an increased confidence that the natural language keyword will be relevant to the user's interests if the same natural language keyword is relevant to two or more activity patterns of the device 1. Additionally or alternatively, the score indicative of a confidence level that the data is relevant to the device may increase as the device 1 approaches a particular position or geographical area (and decrease as the device 1 leaves a particular position or geographical area) or be increased or decreased at particular times (e.g. times of day, days of the week, days of the month, months of the year). Location specific data portions whose relevance parameters match data representing one or more activity patterns with a high confidence rating are typically provided with a higher relevance score by the relevance module than location specific data portions whose relevance parameters match data representing one or more activity patterns with a low confidence rating.

It may be that the user profile comprises a radius value indicating a distance from a current position, or a base location, of the device 1 defining a geographical area surrounding the device, or the base location, such that only location specific data relating to positions within that geographical area are provided to the device 1. The said distance may be fixed or adjustable. For example, the distance a user of the device 1 is willing to travel to take advantage of a special offer specified in location specific data output to the user interface 8 may depend on a mode of transport of the device 1 (e.g. the user may be willing to travel further if driving, but a shorter distance if on foot). The server 2 may track movement of the device (and typically time references associated with the said positions) to determine a mode of transport of the device, and adjust the radius value associated with the user profile responsive to the determined mode of transport. In this case, the user profile may be dynamically updated in accordance with the radius value, such that only location specific data relating to positions within the geographical area defined by the current position of the device or the base location and the radius value are output to the user interface 8 of the device 1.

It may be that the data output to the user interface of the device 1 is interactive. For example, data may be selectable so that it can be viewed in more detail, or so that the user can visit a website related to the content of the data output to the user interface, or so that the user can bid for an item on an online auction site. Optionally, an updateable counter may be provided for counting the number of people who have interacted with the advertisement. For example, every time a user views a media file output to the user interface from or associated with a particular location specific data portion, or bids for an item, the counter may be incremented. This can provide a measure of popularity of a particular advertisement. The popularity of a particular advertisement may provide an additional criterion, for example to determine a priority with which data from or associated with a location specific data portion should be output to the device if, for example, the determined relevance scores of two or more location specific data portions are equal to each other.

By selecting data from or associated with location specific data portions based on a determined relevance of the location specific data portions to one or more activity patterns of the device, location specific data most relevant to the device 1 (based on its activity patterns and optionally based on its current location and a current time) is provided to its user interface 8.

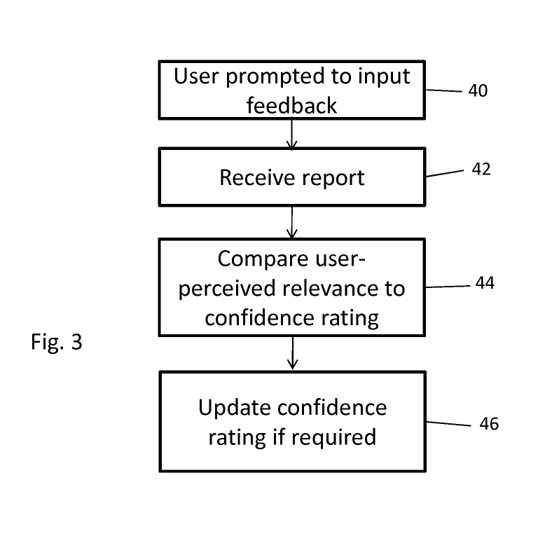

FIG. 3 is a flow diagram illustrating a reporting procedure by which an indication of a user perceived relevance of data from or associated with one or more location specific data portions output to the user interface 8 of the mobile device 1 can be obtained. In a first step 40, when the said data is output to the user interface 8 of the mobile device 1, the user is prompted to indicate whether the data is of interest to him/her (e.g. by prompting the user to click an option which allows him/her to view more details) or whether the data is not of interest to him/her. If the user indicates that the data is not of interest, a further prompt may be provided for the user to indicate a reason why the data was not of interest. For example, the prompt may present one or more options for the user to select as to why the data was not relevant, e.g. the data related to a business located too far from his/her current or base location, the data related to a subject which was of no interest to the user and/or the data was “spam”.

In a next step 42, the server 2 receives the report. The server 2 then compares the user perceived relevance of the data to the confidence rating of data representing the activity pattern which caused the location specific data portion to be selected in a next step 44. If the perceived relevance was expected, the confidence rating can be increased in step 46. If the perceived relevance was not expected, the confidence rating in the user profile can be reduced and/or the user profile can be updated accordingly. Additionally, where the reason provided for a lack of interest in the data is that the data relates to a business located too far from his/her current location, the radius value associated with the device 1 (which as explained above defines how far from the device or its base location the location related to the data may be if it is to be relevant to the device 1) or the size of a corresponding geographical area associated with the location specific data portion, may be amended accordingly.

One or more of the said location specific data portions may be dynamically updated over time. The one or more of the said location specific data portions may be updated responsive to an estimated position or a sequence of estimated positions of the device. More specifically, the server 2 may track movements of the device 1 (e.g. via estimated positions of the device 1 by the positioning module 4 transmitted to the server 2) and amend (update) one or more location specific data portions responsive to a (particular) change in the estimated position of the device. The server 2 may recognise that the device is entering or leaving a particular geographical region (which may contain a particular geographical feature, for example) and update one or more location specific data portions accordingly. For example, the server 2 may track a device 1 approaching or entering a region containing a local business which has produced a location specific data portion containing an advertisement that is determined by the relevance module 13 to be relevant to the mobile device 1. The location specific data portion is selected by the selection module 15 and output to the device as described above. It may be that the server 2 tracks the device 1 leaving the geographical area containing that local business (e.g. having not visited the said local business). Accordingly, the advertisement in the location specific data portion may be dynamically amended (updated) to offer a (larger) discount on one or more products mentioned in the original advertisement, thereby enticing the user of the device 1 to return to visit the business.

Additionally or alternatively one or more of the said location specific data portions may be amended/updated responsive to time. For example, one or more of the said location specific data portions may be updated responsive to a time of day, a day of the week, a month of the year, the year and so on.

Additionally or alternatively, one or more of the said location specific data portions may be amended/updated responsive to a user interaction with the said location specific data portion(s). For example, the data from or associated with the selected location specific data portion(s) may comprise an internet auction site on which a user can input a bid. In this case, the said location specific data portion may be dynamically updated responsive to the said bid.

### Obtaining Data Representing One or More Activity Patterns of the Mobile Device

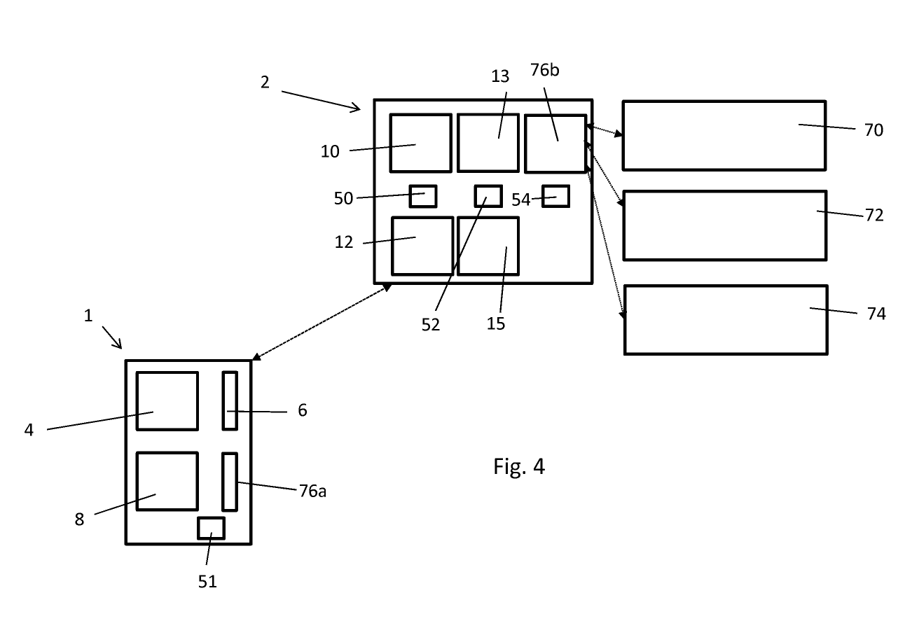

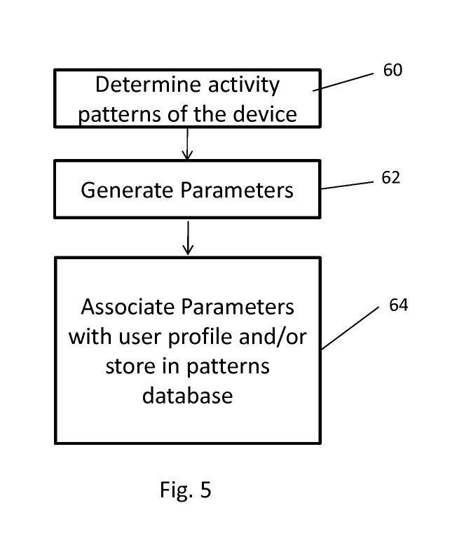

When a new device 1 requests a location specific data portion for the first time, it may be that there is no user profile associated with that device in the user profile database 12, and/or it may be that there is no data relating to activity patterns of the device 1 stored in the patterns database 16. Manually inputted data and reported data input by a user provides a relatively quick way in which a new user profile can be built up in the user profile database 12 for such a new device 1 before patterns of movement/activity category patterns of the device can be determined or knowledge of a user of the device 1 can be built up. Ways in which patterns of movement/activity category patterns of the device can be obtained, and data representing the patterns of movement/activity category patterns can be generated, are described as follows with reference to FIGS. 4 and 5.

FIG. 4 is a more detailed version of the diagram of FIG. 1. As indicated above, the positioning module 4 of the mobile device 1 is configured to estimate the position of the mobile device 1 (where possible). The positioning module 4 is also typically configured to output an updated estimate of the position of the device to the user interface 8 periodically. The positioning module 4 also periodically reports an estimate of the position of the device to the server 2 such that the server 2 can track movement of the device 1 (either as part of a request for location specific data or separately). The server 2 stores the reported estimates of the position of the device 1 in a memory 50. The reported estimates of the position of the device 1 are typically time referenced.

By tracking the movements of the device 1, the following can readily be determined:
Activity patterns of the device, such as daily routes followed by the device, including the times at which a user typically spends at home, the location of a user's home, the times at which a user typically spends at work (or school, college or university), the location of a user's place of work (or school, college or university), the times at which a user typically spends shopping, typical shopping locations, whether a user of the device has particular activity category patterns and so on;
A typical method of travel of the device (e.g. train, bus, walking); and
Whether the device (and thus the user of the device) suddenly travels to a different location (indicating a holiday or a work trip).

The server 2 further comprises an activity pattern identification module 52 configured to determine from the reported estimates of the positions of the device one or more activity patterns of the device 1. In a first step 60 (see FIG. 5) of a method of generating data representing one or more activity patterns of the device, the activity pattern identification module 52 determines one or more activity patterns of the device from the reported estimates of position of the device. The activity patterns may comprise one or more patterns of movement of the device. As indicated above, one or more patterns of movement of the device may comprise one or more “base locations” of the device where the device is regularly based for a (e.g. continuous or discontinuous) period of time greater than a base threshold time period (e.g. 1 hour or 5 hours). Accordingly, one or more patterns of movement of the device may be determined by identifying one or more positions or geographical areas in which the device is regularly (e.g. on successive days, on the same day of the week, on weekdays, at weekends) located for a period of time greater than a base threshold time period. The base locations may comprise the home or place of work of a user of the device 1.

The estimated positions of the device may be grouped into time periods (e.g. such as a first 24 hour period and a second 24 hour period following the first 24 hour period) and patterns of movement of the device may be determined by comparing the estimated positions of the device during a first time period with estimated positions of the device during a second time period and identifying common base locations between the first and second time periods. If a base location is common to two or more of a plurality of time periods, they may be considered to be “verified base locations” (as there can be greater confidence that a base location in common between two or more time periods is indeed a valid “base location” of the device). Data representing verified base locations may be provided with a higher confidence rating than data representing base locations which have been determined but not verified.

One or more of the said patterns of movement of the device 1 may comprise one or more repeated routes of the device. For example, a plurality of routes followed by the device may be determined from the estimated positions of the device 1 reported to the server 2 and two or more such routes may be compared to determine one or more repeated routes of the device. Times associated with each instance of the repeated routes may be compared in order to determine one or more time referenced patterns of movement of the device. For example, one or more repeated routes of the device may be determined by comparing routes followed by the device 1 in each of two or more of the said plurality of time periods.

One or more of the said patterns of movement may comprise one or more repeated positions of the device. Accordingly, the server 2 may determine from the said estimated positions of the device one or more repeated positions of the device, and/or determine from the said location data that the device is repeatedly located in a particular geographical region (e.g. during a single time period, or during each of a plurality of time periods or during each of a plurality of consecutive time periods).

The said patterns of movement of the device and/or data representing and/or related to the said patterns of movement of the device may be stored in the patterns database 16. The patterns of movement and/or data representing and/or related to the said patterns of movement of the device is typically time referenced, the time reference indicating a time (e.g. time of day, day of the week/month, month of the year) at which the pattern of movement is typically followed by the device. The said time reference is typically obtained from time references associated with the estimated positions of the device from which the patterns of movement are derived. The patterns of movement in the patterns database 16 may also be position referenced to a position associated with the respective pattern of movement as discussed above.

The activity pattern identification module 52 also typically determines one or more activity category patterns of the device 1. Activity category patterns are typically indicative that the device regularly and/or frequently visits positions and/or geographical regions, and/or follows routes, having a particular activity category. That is, the one or more activity patterns of the device may be indicative that a user of the device regularly performs in accordance with one or more activities (e.g. at particular times).

In order to determine one or more activity category patterns of the device 1, the pattern identification module firstly categorises two or more (typically all of the) positions of the device and/or routes followed by the device into one an activity category. The activity categories are typically indicative of a type of activity associated with the position of the device or route followed by the device (as appropriate). For example, a position of, or route followed by, the device corresponding with a geographical feature, amenity, business or brand may be categorised into a respective activity category associated with that feature, amenity, business or brand. If a position of the device corresponds with a position of a restaurant, that position may be categorised in a “restaurant” or “eatery” activity category. In order to categorise positions of, or routes followed by, the device, the pattern identification module 52 may compare the said positions or routes may be compared to location specific geographical data from a database of location specific geographical data (e.g. mapping data comprising information regarding local businesses, public buildings, amenities such as train stations or bus terminals, roads, train lines, public parks/spaces and so on). The said database of location specific geographical data may be dynamically updated over time with more businesses including entries in the database indicating their location and activity category. The activity category into which each of the said positions/routes are categorised may be selected from a plurality of predefined categories stored on the server 2, or the activity category may be defined by the business itself. The said database of location specific geographical data may additionally or alternatively comprise data from or be in data communication with publically available mapping databases or location specific residential, business or retail directories (e.g. Google Maps, yell.com or Google Places).

One or more activity category patterns of the device may be determined by comparing the activity categories associated with positions of/routes followed by the device and recognising that two or more positions/routes have activity categories in common. In addition, time references associated with each of the positions of/routes followed by the device having activity categories in common may be compared to determine whether they follow a recognisable pattern in time. It may be that an activity category pattern requires both that activity categories in common between two or more positions/routes and that the times at which those positions are occupied/routes followed follow a recognisable pattern.

The determination of one or more activity category patterns of the device 1 may be aided by data retrieved from one or more social networking websites or search engines. For example, a time referenced post (e.g. location check-in) by a user of the device 1 may be retrieved from a social networking website and data contained within the time referenced post may be used to determine information relating to an estimated position of the device 1. The time referenced post may provide information that the device 1 is inside a shopping mall or cinema complex at a particular time. The time associated with the time referenced post may be used to associate the information derived from the post with an estimated position of the device at the same (or a similar) time. The information derived from the post can be used to categorise the position of the device 1, which may be particularly useful if, for example, it is not available from the mapping data.

The activity category patterns are also typically stored in the patterns database 16.

The activity pattern identification module 52 may compare one or more determined activity patterns with activity patterns stored in the patterns database 16 such that data relating to a determined activity pattern is only stored in the database 16 if it relates to a new activity pattern not currently stored in the database 16. Additionally or alternatively, if a determined activity pattern matches an activity pattern stored in the patterns database 16, a confidence rating of data representing the activity pattern may be increased.

As indicated above, details of activity patterns of a user of the device 1 may also be entered manually by a user, in which case the manually entered details may also be stored in the patterns database 16.

The server 2 (e.g. pattern identification module 52) may be configured to determine that the device 1 has a new activity pattern and/or that it no longer follows an existing activity pattern during use. In the former situation, the new activity pattern data may be stored in the patterns database 16 and the parameter generation module 54 may generate data (e.g. one or more device parameters) representing one or more new activity patterns of the device (and store it in the patterns database or the user profile database)—see below. In the latter situation, the method may comprise removing data representing one or more activity patterns of the device from the user profile (and optionally removing the pattern data from the patterns database 16).

### Generating Data Representing Activity Patterns of Device

Referring back to FIG. 5, in a second step 62, data representing the one or more activity patterns of the device are generated by a parameter generation module 54 of the server 2. The parameter generation module 54 may run continuously or periodically to dynamically update the user profile with the parameters it generates. The data representing the one or more activity patterns typically comprises one or more device parameters, typically including one or more natural language keywords, which may be stored in the user profile of the device 1 in the user profile database 12 for comparison to relevance parameters associated with the location specific data portions.

The parameter generation module 54 may generate device parameters (e.g. natural language keywords) in respect of an activity pattern from the names of, or words associated with, one or more activity categories (e.g. the name of a or the common activity category of an activity category pattern), geographical features, amenities, businesses or brands associated with one or more patterns of movement of the device. Additionally or alternatively, the parameter generation module 54 may generate one or more device parameters (e.g. natural language keywords) responsive to a user interaction with a location specific data portion which has been output to the user interface 8 of the device 1.

A user may wish to seek advertisements or offers relating to a particular product (e.g. coffee discounts) and so may wish to add coffee related parameters to the mobile device. Accordingly, as indicated above, some device parameters may be input manually by a user of the device 1. For example, the user may enter a natural language keyword “coffee” in this instance.

The parameter generation module 54 may generate one or more device parameters responsive to a user selecting a (or a feature of a) location specific data portion which has been output to the user interface 8 of the device 1. For example, the location specific data portion may contain an advertisement relating to a particular brand (or amenity or local business), and the parameter generation module 54 may generate one or more natural language keywords associated with the brand (or amenity or local business) responsive to the user's selection of the advertisement. The keywords may be activity categories associated with the location specific data portions. In another example, the location specific data portion may contain an online auction, and the user may bid for a certain item. The parameter generation module 54 may generate natural language keywords associated with the said item and/or the said auction site and (temporarily or permanently) add them to the user profile. These keywords may be selected from, or be associated with, the location specific data portion containing the advertisement in the location specific database.

The parameter generation module 54 may take into account time data associated with one or more activity patterns of the device when generating the device parameters. For example, if it is determined that the device follows a travelling activity pattern between 0700 and 0900 on weekdays, a natural language keyword “commuter” may be generated. However, it is determined that the device follows a travelling activity pattern at 1000 on a weekend, a natural language keyword “day tripper” may instead be generated. Additionally or alternatively, the parameter generation module 54 may obtain the said time data and store it as a device parameter for comparison with one or more times associated with the location specific data portions.

The parameters (i.e. natural language keywords and optionally time parameters) generated by the parameter generation module 54 may be added to the user profile of the device in a next step 64, the parameters being indicative of the activities of a user of the device 1 (and optionally the time at which the activities typically occur). Additionally or alternatively, the parameters may be stored in the patterns database 16 (the parameters being associated with data relating to the relevant activity pattern in the patterns database). It may be that one or more of the parameters are added to the user profile (e.g. temporarily) responsive to the time and/or an estimated location of the device 1. The parameters may be stored in the patterns database (typically together with a time reference) for use in the user profile later. Alternatively, data relating to the activity patterns of the device 1 may be stored in the patterns database, with device parameters being dynamically generated by the parameter generation module in response to a request by the mobile device 1 for location specific data from the server 2.

The parameter generation module 54 may compare one or more determined parameters with parameters stored in the user profile, and it may be that a determined parameter is only added to the user profile if it is not currently in the user profile. Additionally or alternatively, if a determined parameter matches a parameter in the user profile, the confidence rating associated with the stored parameter may be increased.

In some embodiments the parameter generation module 54 may generate one or more device parameters responsive to a determination that the mobile device 1 is not following an expected activity pattern of the device 1. In this case, the last known location of the device 1 may be used to determine one or more device parameters. For example, if the mobile device does not follow an anticipated “commuting” pattern within a particular time period on a particular day, and the last known location of the device is at a base location such as the user's home, keywords “off day” may be generated. In another example, if the last known location of the mobile device is in another country (e.g. at a tourist destination), a keyword “holiday” may be generated.

Typically, the parameter generation module 54 generates the device parameters (e.g. natural language keywords and where appropriate, the time data) automatically.

The device 1 may be tracked over a period of between a few hours and a few months to build up the user profile database 12 and the patterns database 16.

It may be that a location specific data portion is selected responsive to a determination that the device is located at a position, or in a geographical area, at which it has never previously been located (or at which it rarely visits). In this case, data from or associated with the selected location specific data portion may be output to the user interface of the mobile device. Additionally or alternatively, it may be that a location specific data portion is selected responsive to a determination that the device is located at a position, or in a geographical area, at a time (or during a time period) at which it has never (or rarely) previously been located (e.g. if the device is at a location it rarely visits or has never previously visited or rarely visits at lunchtime, the location specific data portion may comprise one or more advertisements of eateries in or adjacent to the area which are open for lunch).

### Generating Social Parameters

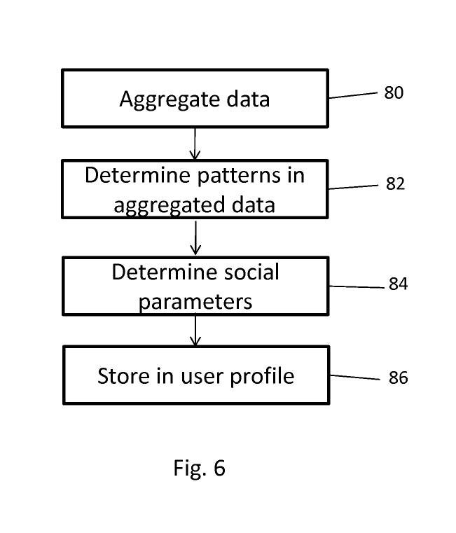

As discussed above, the user profile of the device 1 may further comprise one or more social parameters. FIG. 6 is a flow chart illustrating how one or more social parameters may be generated.

In the example illustrated in FIG. 4, the server 2 may be in electronic data communication with three social networking websites 70-74. The server 2 may also be provided with at least a portion 76b of a data aggregator. Typically, the other portion 76a of the aggregator runs on the mobile device 1 (as illustrated in FIG. 4). The portion 76a of the data aggregator running on the mobile device 1 is configured to gather publically available data from the social networking websites 70-74 relating to the user of the device 1 and, where appropriate, positioning requests made by a user of the device 1 to a positioning engine (which may be provided on the server 2), data from applications which bundle data from social networking applications (e.g. snapp, foursquare), data from the browsing history of the mobile device 1, search history and/or message history (subject to the permission settings on the mobile device being set appropriately). The portion of the aggregator 76a running on the device may also gather time data relating to when the profile was last updated and/or when comments or blog posts were uploaded by the user. Personal information such as the name of the user is not typically gathered, and the device 1 (and thus the user) is identified by a pseudo anonymous identifier such as the IMEI of the user's mobile smartphone or the IMSI of the user's sim card.

The portion 76a of the aggregator running on the device 1 filters the gathered data, removing references to personal identities or references (but keeping a pseudo-anonymous identifier associated with the device such as SIM IMSI or a device IMEI), keeping time and location data together with selected general text from which information regarding the user's activity habits can be determined. The portion of the aggregator 76a running on the device 1 then transmits the filtered data to the portion 76b of the aggregator running on the server 2. The portion 76b of the aggregator running on the server 2 collects and sorts all of the above data for processing by the pattern identification module 52 and the parameter generation module 54. The aggregator may sort the data into an order, e.g. chronological order or order of distance of an estimated location of the device when a post was made from one or more base locations of the device 1, prior to processing.

The pattern identification module 52 and parameter generation module 54 are in electronic data communication with the portion 76b of the aggregator running on the server 2. The pattern identification module 52 and parameter generation module 54 are configured to process the data gathered by the aggregator in order to extract potentially useful information regarding the user. In a next step 82, the data may be processed by the pattern identification module 52 to determine patterns in the sorted data, such as repeated activities by the user (which may be indicated by check-in data at locations having particular categories—see above—or by repeated keywords appearing in posts on the social networking sites 70-74). The patterns determined by the pattern identification module are then passed to the parameter generation module 54 which then generates one or more social parameters indicative of one or more interests or activities of the user of the device for adding to the user profile in a next step 84.

In some embodiments, a database of (e.g. well-known) keywords may be provided. In this case, the sorted, aggregated data may be compared to the database of keywords. Keywords from the keywords database which match (e.g. keywords within) the sorted, aggregated data may be added to the user profile.

The pattern identification module 52 may determine matches between user data (e.g. acquired from one or more social networking websites, search engines and/or search databases) and natural language keywords from the keywords database and the parameter generation module 54 (which is typically in data communication with the keywords database, where provided) may be configured to add the matching keywords (permanently or, more typically, temporarily) to the user profile.

It will be understood that the social parameters may be updated (e.g. added to or removed from the user profile) by the aggregator, pattern identification module 52 and parameter generation module 54 periodically or continuously.

Additionally or alternatively, social parameters may be manually entered or updated by the user to the device 1 and uploaded to the user profile on the server 2.

Although many of the steps described above are described as being performed by the server 2, it will be understood that the mobile device 1 may perform some or all of these steps.

The user profile may be stored on that device 1 rather than at the server 2. In this case, the device and social parameters may be included in a request for data made by the device 1 to the server 2.

The database of location specific data portions may additionally or alternatively be stored on the mobile device 1 rather than the server 2, or a portion of the database 10 may be downloaded from the server 2 to the mobile device 1 periodically.

The pattern identification module 52 may also be provided on the mobile device 1 rather than on the server 2. Similarly, the parameter generation module 54 may be provided on the mobile device 1 rather than the server 2. It will be understood that the pattern identification module 52 and/or the parameter generation module 54 may be distributed across the mobile device 1 and the server 2.

Although the location specific data portions described above are described as relating to advertisements, it will be understood that one or more of the location specific data portions could instead relate to other location specific information, such as train, aeroplane or bus schedules or traffic conditions.

Additional data may be output to the user interface, for example, it may be determined that the device is breaking, or has broken, an activity pattern previously associated with the device, and a message which is not related to the current location of the device may instead be displayed. For example, an advert for a coffee shop might be delivered to a device responsive to determination that the device has broken a normal Monday to Friday pattern of visiting a coffee shop between 7 am and 9 am.

In some embodiments, the device may transmit data from or associated with one or more location specific data portions to one or more further devices over an ad hoc network, such as a peer-to-peer network. The ad hoc network may be facilitated by a Bluetooth connection or Wi-Fi connection (for example). The one or more further devices may be devices located within a predetermined (fixed or adjustable) distance of the device 1 and operable to form a (typically wireless) electronic data communication path with the device 1. This allows data transmitted to the device 1 to be propagated to other devices which may not necessarily be in direct communication with the server 2.

Further variations and modifications may be made within the scope of the invention herein described.

1. A method of outputting location specific data to a user interface of a mobile device, the method comprising: obtaining data representing one or more activity patterns associated with the mobile device; selecting a location specific data portion from one or more location specific data portions responsive to a determination that the data representing one or more of the one or more activity patterns meet one or more relevance criteria associated with the said location specific data portion; and outputting to the user interface data from the selected location specific data portion or data associated with the selected location specific data portion.

2. A method according to claim 1 wherein the said one or more activity patterns comprise one or more patterns of movement of the device.

3. A method according to claim 1 further comprising obtaining location data indicative of a plurality of positions of the mobile device.

4. A method according to claim 3 further comprising determining from the location data one or more routes followed by the device.

5. A method according to claim 3 further comprising categorising each of one or more positions of the device from the location data into one or more activity categories and/or determining from the location data one or more routes followed by the device and categorising each of the said one or more routes followed by the device into one or more activity categories.

6. A method according to claim 5 further comprising determining one or more activity category patterns of the device by comparing the activity categories associated with position(s) of the device from the location data and/or with one or more routes followed by the device.

7. A method according to claim 1 wherein the step of obtaining data representing one or more activity patterns of the device comprises retrieving said data from a user profile.

8. A method according to claim 7 wherein data representing one or more activity patterns is added to or removed from the user profile responsive to a determination that the mobile device is at or is approaching a position associated with the said activity patterns.

9. A method according to claim 7 further comprising: receiving a request for one or more location specific data portions; and adding to or removing from the user profile data representing one or more activity patterns responsive to a determination that a time associated with the request for one or more location specific data portions matches or no longer matches time data associated with the said activity patterns.

10. A method according to claim 1 further comprising transmitting data from the selected location specific data portion or data associated with the selected location specific data portion to the mobile device.

11. A method according to claim 10 further comprising a server transmitting data from the selected location specific data portion or data associated with the selected location specific data portion to the mobile device.

12. A method according to claim 11 further comprising the server transmitting data from the selected location specific data portion or data associated with the selected location specific data portion to the mobile device in response to a request received by the server from the mobile device.

13. A method according to claim 11 further comprising the server transmitting data from the selected location specific data portion or data associated with the selected location specific data portion to the mobile device without having to receive a request from the mobile device.

14. A method according to claim 13 further comprising the server transmitting the data from the selected location specific data portion or data associated with the selected location specific data portion to the mobile device responsive to a determination that the data representing one or more activity patterns of the device meets one or more relevance criteria associated with the said location specific data portion.

15. A method according to claim 13 further comprising the server transmitting the data from the selected location specific data portion or data associated with the selected location specific data portion to the mobile device at one or more particular times.

16. A method according to claim 13 further comprising the server transmitting the data from the selected location specific data portion or data associated with the selected location specific data portion to the mobile device responsive to a determination that the mobile device is at a particular position or in a particular geographical region.

17. A method according to claim 1 wherein the data representing one or more activity patterns comprises one or more device parameters.

18. A method according to claim 1 further comprising: generating one or more device parameters representing one or more activity patterns of the mobile device.

19. A method according to claim 17 further comprising comparing one or more device parameters to one or more relevance parameters associated with one or more location specific data portions and selecting a location specific data portion from the one or more location specific data portions responsive to a determination that one or more of the said one or more device parameters matches one or more relevance parameters associated with the said location specific data portion.

20. A method according to claim 17 wherein the said one or more device parameters comprise one or more natural language keywords.

21. A method according to claim 17 wherein the said one or more device parameters comprise one or more social parameters derived from collected user data relating to a user of the device.

22. A method according to claim 1 further comprising: selecting a location specific data portion responsive to a determination that the device is located at a position, or in a geographical area, at which it has never previously been located, or which it rarely visits, or which is indicative that the device is breaking an activity pattern which it has previously followed; and outputting data from or associated with the said selected location specific data portion to the user interface of the device.

23. A method according to claim 1 further comprising dynamically updating one or more of the said location specific data portions responsive to an estimated position or a sequence of estimated positions of the device.

24. Data processing apparatus comprising:
a. a mobile device having a user interface;
b. a location specific database comprising one or more location specific data portions;
c. a user profile database containing at least one user profile comprising data representing one or more activity patterns of the mobile device;
d. a selection module configured to select a location specific data portion from the location specific database responsive to a determination that data representative of one or more of the activity patterns meet one or more relevance criteria associated with the said location specific data portion; and
e. an output module configured to output data from the selected location specific data portion(s) or data associated with the selected location specific data portions to the user interface of the mobile device.

25. A method of generating data representing one or more activity patterns of a mobile device, the method comprising: obtaining location data indicative of a plurality of locations of the mobile device; determining from the location data one or more activity patterns of the device; and generating one or more device parameters representing the said one or more activity patterns.

26. Data processing apparatus comprising:
a. a mobile device;
b. a positioning module configured to obtain location data indicative of a plurality of positions of the mobile device;
c. a pattern identification module in data communication with the positioning module for determining one or more activity patterns from location data obtained from the positioning module; and
d. a parameter generation module in data communication with the pattern identification module for generating data representing one or more activity patterns of the device determined by the pattern identification module.

27. A method of generating data representing one or more interests or habits of a user of a mobile device, the method comprising: collecting user data relating to a user of a mobile device; determining one or more patterns in the user data; and determining one or more social parameters indicative of one or more interests or habits of the user from the patterns in the user data.

28. Data processing apparatus comprising:
a. a mobile device;
b. an aggregator in data communication with the mobile device for collecting user data relating to a user of the mobile device;
c. a pattern recognition module in data communication with the aggregator for determining one or more patterns in the collected user data; and
d. a parameter generation module in data communication with the pattern recognition module for generating one or more social parameters indicative of the interests or habits of the user from the one or more patterns in the collected user data.

29. A non-transitory computer readable medium retrievably storing computer readable code for causing a computer to perform the steps of the method according to claim 1.
